(19) United States
(12) Patent Application Publication
(10) Pub. No.: US 2025/0056580 A1
(43) Pub. Date: Feb. 13, 2025

(54) CONTROL CHANNEL MONITORING ADAPTATION FOR A MULTICAST BROADCAST SERVICE

(71) Applicant: QUALCOMM Incorporated, San Diego, CA (US)

(72) Inventors: Le LIU, San Jose, CA (US); Umesh PHUYAL, San Diego, CA (US); Jae Ho RYU, San Diego, CA (US)

(21) Appl. No.: 18/748,560

(22) Filed: Jun. 20, 2024

Related U.S. Application Data
(60) Provisional application No. 63/519,163, filed on Aug. 11, 2023.

(51) Int. Cl. H04W 72/30; H04W 72/232

(52) U.S. Cl. CPC H04W 72/30; H04W 72/232

(57) ABSTRACT

Various aspects of the present disclosure generally relate to wireless communication. Some aspects relate generally to control channel monitoring adaptation for a multicast broadcast service (MBS). Some aspects more specifically relate to defining an applicability of control channel monitoring adaptation for a search space that is configured for monitoring a control channel associated with the MBS. In some aspects, a user equipment (UE) may receive a configuration for a search space for monitoring a control channel for downlink control information (DCI) that is associated with the MBS. Additionally, one or more control channel monitoring adaptation parameters may be applicable to the search space. In some aspects, an application of control channel monitoring adaptation when monitoring the control channel (via the search space) for DCI that is associated with the MBS may be associated with a radio resource control state of the UE.

### CROSS-REFERENCE TO RELATED APPLICATION

This Patent Application claims priority to U.S. Provisional Patent Application No. 63/519,163, filed on Aug. 11, 2023, entitled “CONTROL CHANNEL MONITORING ADAPTATION FOR A MULTICAST BROADCAST SERVICE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically, to techniques and apparatuses associated with control channel monitoring (for example, physical downlink control channel (PDCCH) monitoring) adaptation for a multicast broadcast service (MBS).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipments (UEs) to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some examples, a wireless network may support a multicast broadcast service (MBS) to enable the simultaneous dissemination of data to multiple UEs that may be located in the same or different cells, such as for emergency alerts, and/or audio or video content, among other examples. In general, because MBS operations enable multiple UEs to receive the same data at substantially the same time, MBS operations can significantly reduce network overhead, relative to unicast operations in which a particular transmission is received by only one UE. In some examples, a network node may transmit a communication associated with the MBS via a given search space type. For example, a common search space (CSS) can be configured as a search space associated with communicating downlink control information (DCI) associated with the MBS. For example, a UE may monitor a control channel (for example, a physical downlink control channel (PDCCH)) via a search space having the given search space type for DCI associated with the MBS. The given type of search space may include a Type3-PDCCH CSS (for example, as defined, or otherwise fixed, by a wireless communication standard, such as the 3GPP).

The wireless network may also support control channel monitoring adaptation (for example, physical downlink control channel (PDCCH) monitoring adaptation) that enables a manner in which the UE monitors a control channel (for example, the PDCCH) to be adapted. One example of control channel monitoring adaptation is search space (SS) set group (SSSG) switching. As described herein, an SSSG may be a group of one or more search space sets. In some examples, multiple groups (for example, two or more groups) of search space sets may be configured. The UE may receive an indication (for example, via DCI) of which SSSG, from multiple configured SSSGs, is to be actively monitored by the UE (for example, the UE may monitor a single SSSG from the multiple configured SSSGs at a time). Another example of control channel monitoring adaptation is PDCCH skipping. PDCCH skipping refers to a UE skipping the monitoring of a PDCCH (for example, refraining from monitoring the PDCCH) for some period of time. For example, the UE may receive an indication to perform PDCCH skipping (for example, an indication to skip PDCCH monitoring) for a given duration.

In some examples, control channel monitoring adaptation may be applied for one or more search space types. For example, control channel monitoring adaptation may be applied for UE specific search spaces (USSs) and/or for Type3-PDCCH CSSs. The UE may always monitor other search spaces regardless of whether control channel monitoring adaptation is activated or triggered. However, as described above, MBS (for example, for MBS multicast and/or for MBS broadcast) and control channel monitoring adaptation may be applicable to the same search space type(s). For example, a Type3-PDCCH CSS may be configured to enable a UE to monitor for DCI formats associated with the MBS. Additionally, control channel monitoring adaptation may be applicable to Type3-PDCCH CSSs. Therefore, in some examples, a UE may receive an indication that control channel monitoring adaptation is to be applied to a search space (for example, a Type3-PDCCH CSS) that is configured for monitoring for DCI formats associated with the MBS.

However, control channel monitoring adaptation operations are not defined for the MBS (for example, the control channel monitoring adaptation operations are only defined for monitoring for DCI formats associated with scheduling unicast data). Therefore, because the control channel monitoring adaptation operations are not defined for the MBS, the UE and the network node may not be synchronized as to how, or if, control channel monitoring adaptation is to be applied to UE control channel monitoring operation(s) for monitoring for DCI formats associated with the MBS. As a result, the UE may perform the control channel monitoring adaptation associated with monitoring a control channel for DCI formats associated with the MBS (for example, when the network node does not expect that the control channel monitoring adaptation to be performed by the UE or expects the control channel monitoring adaptation to be performed by the UE in a different manner than is performed by the UE), resulting in the UE failing to receive one or more DCI communications associated with the MBS. Alternatively, the UE may not perform the control channel monitoring adaptation associated with monitoring a control channel for DCI formats associated with the MBS (for example, when the network node expects the control channel monitoring adaptation to be performed by the UE), resulting in the UE consuming processing resources, computing resources, and/or power resources associated with needlessly monitoring the search space for DCI formats associated with scheduling MBS data (for example, because the network node may refrain from transmitting DCI communications via the search space when the network node expects the control channel monitoring adaptation to be applied).

### SUMMARY

Some aspects described herein relate to a user equipment (UE) for wireless communication. The UE may include a processing system that includes one or more processors and one or more memories coupled with the one or more processors. The processing system may be configured to cause the UE to receive configuration information for a search space associated with a search space type for which one or more control channel monitoring adaptation parameters are applicable. The processing system may be configured to cause the UE to perform, in a radio resource control (RRC) state and via the search space, control channel monitoring for one or more downlink control information (DCI) formats that are associated with a multicast broadcast service (MBS), an application of the one or more control channel monitoring adaptation parameters to the control channel monitoring being associated with the RRC state.

Some aspects described herein relate to a network node for wireless communication. The network node may include a processing system that includes one or more processors and one or more memories coupled with the one or more processors. The processing system may be configured to cause the network node to transmit configuration information for a search space associated with a search space type for which one or more control channel monitoring adaptation parameters are applicable. The processing system may be configured to cause the network node to transmit, via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE.

Some aspects described herein relate to a method of wireless communication by a UE. The method may include receiving configuration information for a search space associated with a search space type for which one or more control channel monitoring adaptation parameters are applicable. The method may include performing, in an RRC state and via the search space, control channel monitoring for one or more DCI formats that are associated with an MBS, an application of the one or more control channel monitoring adaptation parameters to the control channel monitoring being associated with the RRC state.

Some aspects described herein relate to a method of wireless communication by a network node. The method may include transmitting configuration information for a search space associated with a search space type for which one or more control channel monitoring adaptation parameters are applicable. The method may include transmitting, via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE.

Some aspects described herein relate to a non-transitory computer-readable medium that stores a set of instructions for wireless communication by a UE. The set of instructions, when executed by one or more processors of the UE, may cause the UE to receive configuration information for a search space associated with a search space type for which one or more control channel monitoring adaptation parameters are applicable. The set of instructions, when executed by one or more processors of the UE, may cause the UE to perform, in an RRC state and via the search space, control channel monitoring for one or more DCI formats that are associated with an MBS, an application of the one or more control channel monitoring adaptation parameters to the control channel monitoring being associated with the RRC state.

Some aspects described herein relate to a non-transitory computer-readable medium that stores a set of instructions for wireless communication by a network node. The set of instructions, when executed by one or more processors of the network node, may cause the network node to transmit configuration information for a search space associated with a search space type for which one or more control channel monitoring adaptation parameters are applicable. The set of instructions, when executed by one or more processors of the network node, may cause the network node to transmit, via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE.

Some aspects described herein relate to an apparatus for wireless communication. The apparatus may include means for receiving configuration information for a search space associated with a search space type for which one or more control channel monitoring adaptation parameters are applicable. The apparatus may include means for performing, in an RRC state and via the search space, control channel monitoring for one or more DCI formats that are associated with an MBS, an application of the one or more control channel monitoring adaptation parameters to the control channel monitoring being associated with the RRC state.

Some aspects described herein relate to an apparatus for wireless communication. The apparatus may include means for transmitting configuration information for a search space associated with a search space type for which one or more control channel monitoring adaptation parameters are applicable. The apparatus may include means for transmitting, via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of a multicast broadcast service (MBS) architecture in accordance with the present disclosure.

FIG. 5 is a diagram illustrating an example resource structure for wireless communication in accordance with the present disclosure.

FIG. 6 is a diagram of an example associated with operations associated with control channel monitoring adaptation for an MBS in accordance with the present disclosure.

FIG. 7 is a flowchart illustrating an example process performed, for example, at a UE or an apparatus of a UE that supports control channel monitoring adaptation for an MBS in accordance with the present disclosure.

FIG. 8 is a flowchart illustrating an example process performed, for example, at a network node or an apparatus of a network node that supports control channel monitoring adaptation for an MBS in accordance with the present disclosure.

FIG. 9 is a diagram of an example apparatus for wireless communication that supports control channel monitoring adaptation for an MBS in accordance with the present disclosure.

FIG. 10 is a diagram of an example apparatus for wireless communication that supports control channel monitoring adaptation for an MBS in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to control channel monitoring adaptation (for example, physical downlink control channel (PDCCH) monitoring adaptation) for a multicast broadcast service (MBS). Some aspects more specifically relate to defining an applicability of control channel monitoring adaptation for a search space that is configured for monitoring a control channel associated with the MBS. In some aspects, a user equipment (UE) may receive a configuration for a search space (for example, a Type3-PDCCH common search space (CSS)) indicating that the search space is configured for monitoring a control channel (for example, a PDCCH) for downlink control information (DCI) that is associated with the MBS (for example, that is associated with multicast operations and/or broadcast operations). Additionally, one or more control channel monitoring adaptation parameters may be applicable to the search space. In some aspects, the UE may apply control channel monitoring adaptation (for example, as indicated by the one or more control channel monitoring adaptation parameters) when monitoring the control channel (via the search space) for DCI that is associated with the MBS. In other aspects, the UE may refrain from applying control channel monitoring adaptation (for example, even if indicated by the one or more control channel monitoring adaptation parameters) when monitoring the control channel (via the search space) for DCI that is associated with the MBS.

In some aspects, the UE may apply the one or more control channel monitoring adaptation parameters (for example, may apply PDCCH monitoring adaptation) when monitoring the control channel (via the search space) for DCI that is associated with the MBS based on, responsive to, or otherwise associated with one or more factors. In some aspects, the one or more factors may include a radio resource control (RRC) state of the UE. For example, if the RRC state of the UE is the RRC inactive state or the RRC idle state, then the UE may refrain from applying control channel monitoring adaptation (for example, even if indicated by the one or more control channel monitoring adaptation parameters) when monitoring the control channel (via the search space) for DCI that is associated with the MBS (for example, control channel monitoring adaptation may not be applicable for MBS control channel monitoring for UEs operating in the RRC inactive state or the RRC idle state). As another example, if the RRC state of the UE is the RRC connected state, then the UE may apply control channel monitoring adaptation when monitoring the control channel (via the search space) for DCI that is associated with the MBS (for example, control channel monitoring adaptation may be applicable for MBS control channel monitoring for UEs operating in the RRC connected state). In other aspects, control channel monitoring adaptation may not be applicable for MBS control channel monitoring for UEs operating in the RRC connected state.

As another example, the one or more factors may be based on, responsive to, or otherwise associated with information indicated via a control channel monitoring adaptation configuration. For example, an SSSG configuration may configure one or more SSSGs. In some aspects, the one or more factors may include whether the search space (for example, a Type3-PDCCH CSS) is associated with an SSSG that is configured via an SSSG configuration (for example, if the SSSG configuration indicates one or more search space group identifiers associated with the search space). In such examples, the search space may not be used for monitoring an MBS control channel. For example, a Type3-PDCCH CSS may be either indicated via an SSSG configuration or may be configured for MBS control channel monitoring, but not both.

In some aspects, control channel monitoring adaptation (for example, SSSG switching and/or PDCCH skipping) may not be applicable for MBS control channel monitoring (for example, via the Type3-PDCCH CSS) associated with monitoring for DCI formats associated with the MBS and for unicast DCI formats that are associated with scheduling a retransmission of an MBS data communication. In other aspects, control channel monitoring adaptation (for example, SSSG switching and/or PDCCH skipping) may not be applicable for MBS control channel monitoring (for example, via the Type3-PDCCH CSS) associated with monitoring for DCI formats associated with the MBS, but may be applicable for monitoring for the unicast DCI formats (for example, the UE may skip monitoring for the unicast DCI formats via the Type3-PDCCH CSS if a control channel monitoring adaptation parameter is indicated).

For example, control channel monitoring adaptation (for example, SSSG switching and/or PDCCH skipping) may be associated with a timer (for example, an SSSG switching timer). The timer may be applicable to both unicast traffic and MBS traffic. If control channel monitoring adaptation is applicable for MBS control channel monitoring, then the UE may reset the timer based on, in response to, or otherwise associated with receiving DCI having a DCI format associated with MBS (for example, DCI scrambled by an MBS radio network temporary identifier (RNTI), such as an MBS multicast RNTI). If the control channel monitoring adaptation is not applicable for MBS control channel monitoring, then the UE may refrain from resetting (for example, may not reset) the timer based on, in response to, or otherwise associated with receiving DCI having a DCI format associated with MBS (for example, DCI scrambled by an MBS RNTI, such as an MBS broadcast RNTI). This may enable the UE to apply the control channel monitoring adaptation for MBS traffic, such as MBS multicast traffic, if the control channel monitoring adaptation is applicable for the MBS traffic.

Particular aspects of the subject matter described in this disclosure can be implemented to realize one or more of the following potential advantages. In some examples, the described techniques can be used to synchronize the application of control channel monitoring adaptation for MBS control channel monitoring (for example, so that both a network node and the UE are synchronized as to how or if the UE is applying the control channel monitoring adaptation for MBS control channel monitoring). As a result, the UE may receive one or more DCI communications associated with the MBS that may have otherwise been undetected and/or not received in association with the UE and the network node being unsynchronized as to the application of control channel monitoring adaptation for MBS control channel monitoring. Additionally, by enabling the UE to perform or apply control channel monitoring adaptation for MBS control channel monitoring (for example, in some scenarios), the UE may conserve processing resources, computing resources, and/or power resources that would have otherwise been consumed in association with needlessly monitoring the search space for DCI formats associated with scheduling MBS data (for example, because the network node may refrain from transmitting DCI communications via the search space when the network node expects the control channel monitoring adaptation to be applied). In some examples, by applying the control channel monitoring adaptation for monitoring a search space (for example, a Type3-PDCCH CSS) for unicast DCI formats and not for MBS DCI formats, the UE may conserve processing resources, computing resources, and/or power resources that would have otherwise been used to monitor a control channel via a Type3-PDCCH CSS for the unicast DCI format(s), while still enabling the UE to receive DCI that uses an MBS DCI formats via the control channel and/or the Type3-PDCCH CSS.

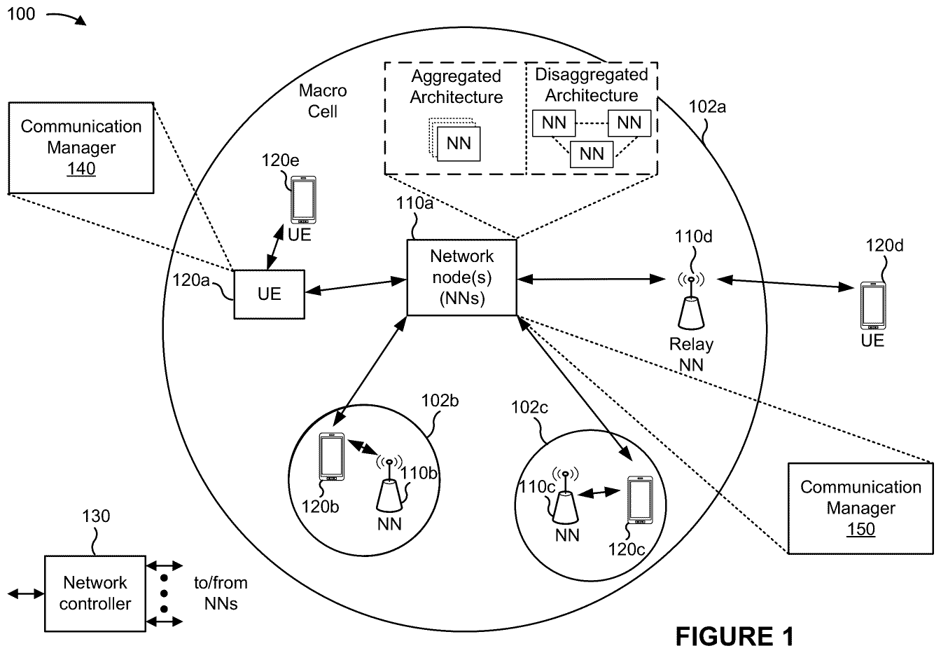

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move in accordance with the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some examples, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

In some examples, a UE 120 may include a processing system. Similarly, a network node 110 may include a processing system. A processing system may include one or more components described herein. A processing system may generally be a system or a series of machines or components that receives inputs and processes the inputs to produce a set of outputs (which may be passed to other systems or components of, for example, a UE 120 or a network node 110 described herein). For example, a processing system of a device (for example, a UE 120 or a network node 110) may be a system that includes the various other components or subcomponents of the device. For example, a processing system may include one or more memories, and/or one or more processors (for example, coupled to the one memories), among other examples

A processing system of a device described herein may interface with one or more other components of the device, may process information received from one or more other components (such as inputs or signals), or may output information to one or more other components. For example, a chip or modem of the device may include a processing system, a first system interface to receive or obtain information, and a second system interface to output, transmit, or provide information. In some examples, the first system interface may be an interface between the processing system of the chip or modem and a receiver, such that the device may receive information or signal inputs, and the information may be passed to the processing system. In some examples, the second system interface may be an interface between the processing system of the chip or modem and a transmitter, such that the device may transmit information output from the chip or modem. The second system interface may also obtain or receive information or signal inputs, and the first system interface may also output, transmit, or provide information.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive configuration information for a search space associated with a search space type for which one or more control channel monitoring adaptation parameters are applicable; and perform, in an RRC state and via the search space, control channel monitoring for one or more DCI formats that are associated with an MBS, an application of the one or more control channel monitoring adaptation parameters to the control channel monitoring being associated with the RRC state. Additionally or alternatively, the communication manager 140 may perform one or more other operations described herein.

In some aspects, the network node 110 may include a communication manager 150. As described in more detail elsewhere herein, the communication manager 150 may transmit configuration information for a search space associated with a search space type for which one or more control channel monitoring adaptation parameters are applicable; and transmit, via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE. Additionally or alternatively, the communication manager 150 may perform one or more other operations described herein.

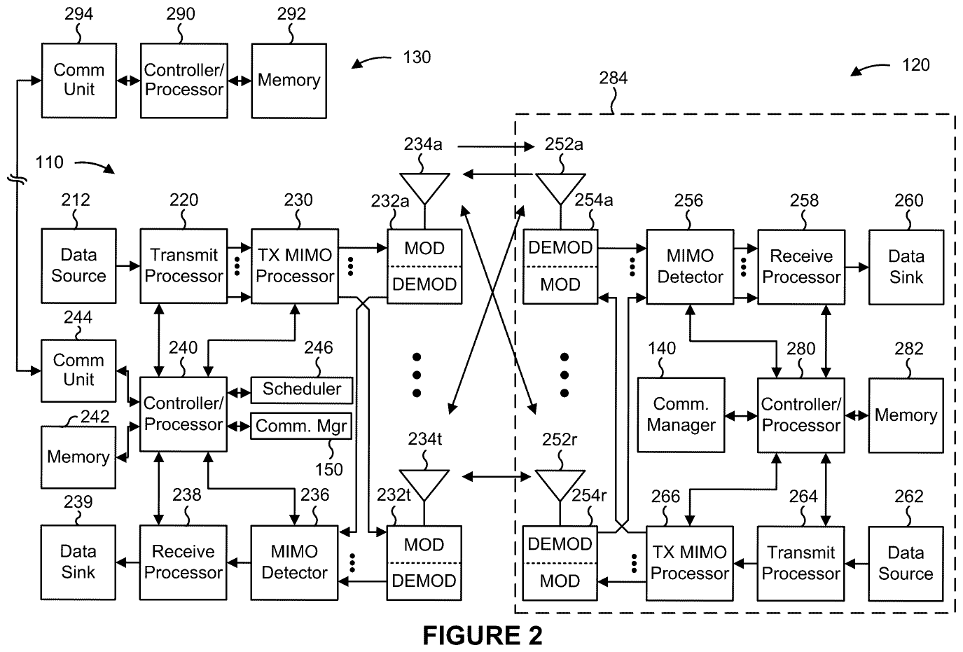

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

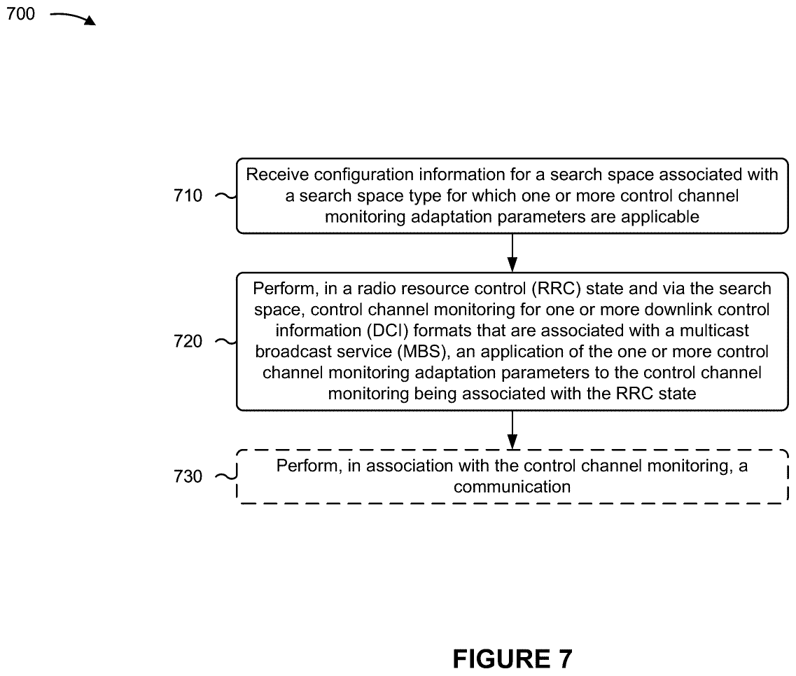

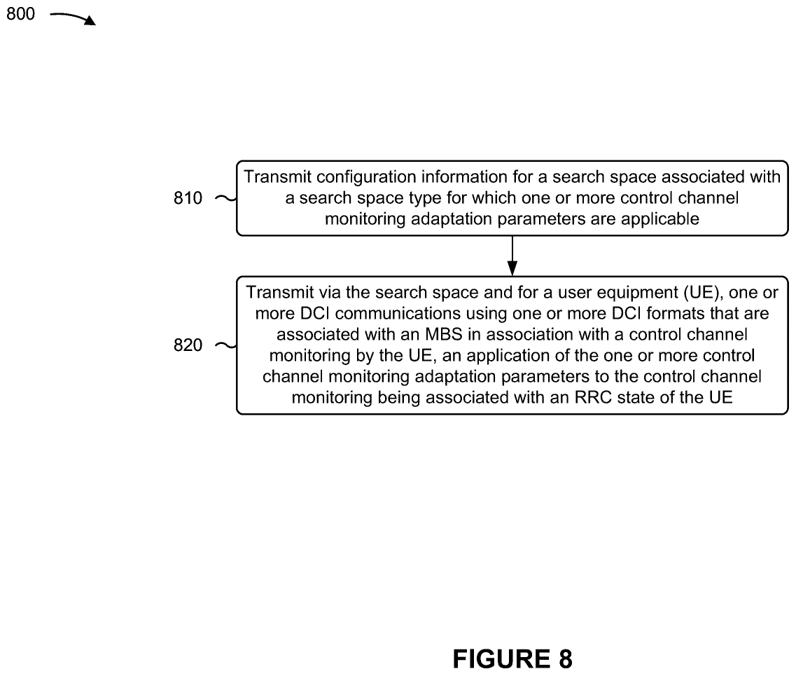

The controller/processor 240 of the network node 110, the controller/processor 280 of the UE 120, or any other component(s) of FIG. 2 may perform one or more techniques associated with control channel monitoring adaptation for an MBS, as described in more detail elsewhere herein. For example, the controller/processor 240 of the network node 110, the controller/processor 280 of the UE 120, or any other component(s) of FIG. 2 may perform or direct operations of, for example, process 700 of FIG. 7, process 800 of FIG. 8, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, or other processes as described herein. In some examples, executing instructions may include running the instructions, converting the instructions, compiling the instructions, or interpreting the instructions, among other examples.

In some aspects, the UE 120 includes means for receiving configuration information for a search space associated with a search space type for which one or more control channel monitoring adaptation parameters are applicable; and/or means for performing, in an RRC state and via the search space, control channel monitoring for one or more DCI formats that are associated with an MBS, an application of the one or more control channel monitoring adaptation parameters to the control channel monitoring being associated with the RRC state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information for a search space associated with a search space type for which one or more control channel monitoring adaptation parameters are applicable; and/or means for transmitting, via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

As used herein, the network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (for example, triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” or “receiving” a communication may refer to receiving a transmission carrying the communication directly (for example, from the UE 120 to the network node 110) or receiving the communication (or information derived from reception of the communication) via one or more other network nodes or devices. In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

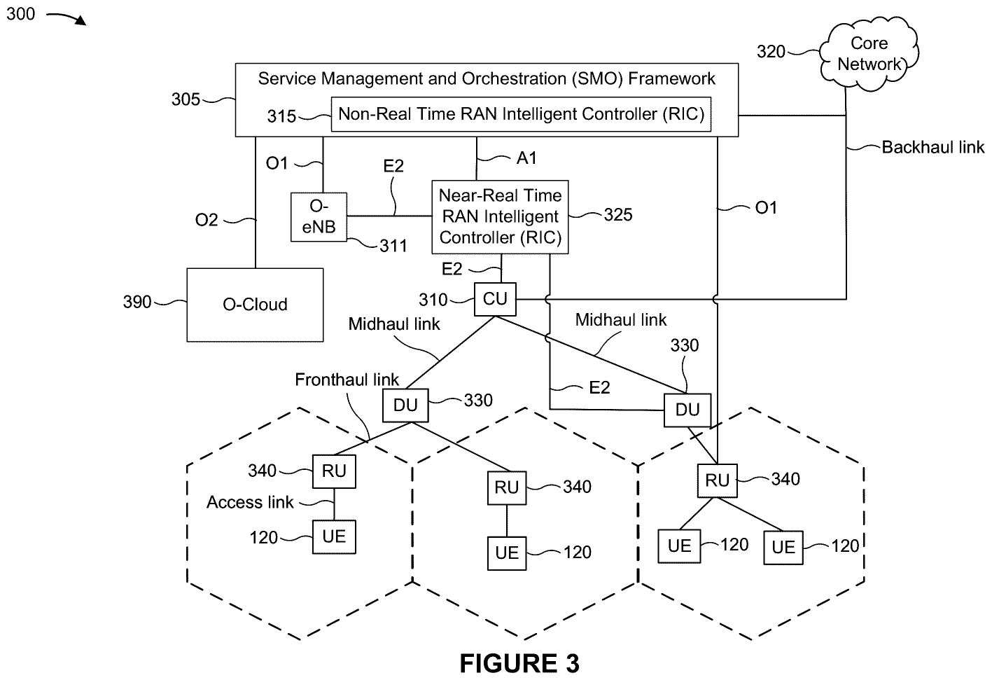

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

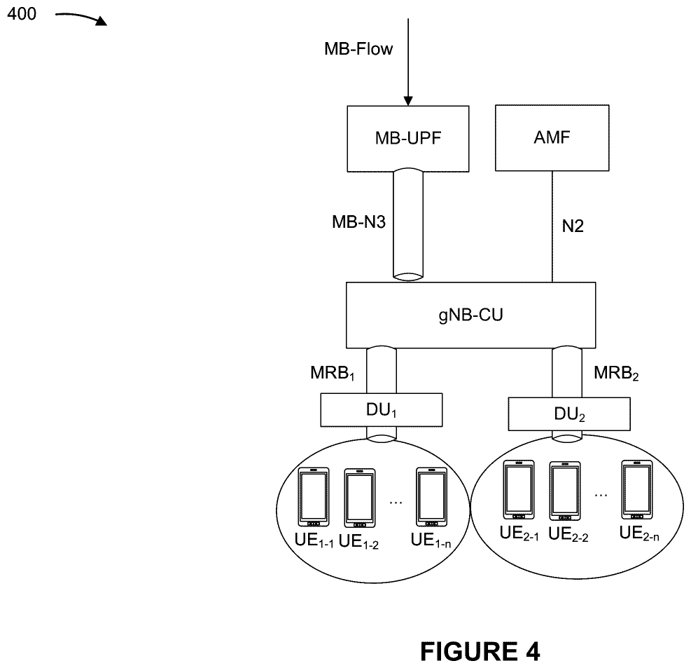

FIG. 4 is a diagram illustrating an example of an MBS architecture 400 in accordance with the present disclosure. In some examples, the MBS architecture 400 may be deployed in a wireless network (for example, wireless network 100) to support multicast or broadcast services to simultaneously disseminate data, such as emergency alerts or audio or video content, among many other possibilities, to multiple UEs that may be located in the same or different cells. In general, because MBS operations enable multiple UEs to receive the same data at substantially the same time, MBS operations can significantly reduce network overhead relative to unicast operations in which a particular transmission is received by only one UE.

In some examples, an MBS communication may include a multicast communication. A multicast communication may be a communication of information to a plurality (for example, a set) of UEs 120. In some examples, each of the UEs 120 may need to join a multicast session prior to receiving information using the multicast communication. For example, the UEs 120 may join the multicast session using non-access stratum (NAS) based signaling. In some examples, the UEs 120 may need to be authorized, or authenticated, prior to joining the multicast session. For example, a network node 110 may indicate to a UE 120, of the set of UEs 120, whether the UE 120 is authorized or authenticated prior to the UE 120 joining the multicast session and receiving information via a multicast communication. In some examples, not all of the UEs 120 within an area (for example, a multicast service area) may receive the information via the multicast communication. For example, the network node 110 may transmit the information to a subset of the UEs 120, of the set of UEs 120, within the multicast service area. In some examples, a UE 120 in the multicast service area that has not been authorized or authenticated may not receive the information via the multicast communication. In some examples, the network node 110 may store information indicative of (for example, may be aware of) whether or not individual UEs 120, of the set of UEs 120, have received the information using the multicast communication. In some examples, a multicast communication may be referred to as a “one-to-many” communication.

In some examples, an MBS communication may include a broadcast communication. A broadcast communication may be a communication of information to all UEs 120 within an area (for example, a broadcast service area). The UEs 120 may not need to join a session prior to receiving the information using the broadcast communication. For example, the UEs 120 do not need to access a session using NAS based signaling prior to receiving the information using the broadcast communication. In some examples, the UEs 120 may not need to be authorized, or authenticated, prior to receiving information via a broadcast communication. In some examples, a network node 110 may transmit the information to all of the UEs 120 within the broadcast service area. For example, the network node 110 may not be able to broadcast the information to only a subset of the UEs 120. In some examples, the network node 110 may not store information indicative of (for example, may not be aware of) whether or not individual UEs 120, of the set of UEs 120, have received the information using the broadcast communication. In some examples, a broadcast communication may be referred to as a “one-to-all” communication.

In a wireless network, MBS operations may be supported using enhanced multimedia broadcast/multicast service (eMBMS), single-cell point-to-multipoint (SC-PTM) services, multimedia broadcast multicast service over single frequency network (MBSFN), or enhanced TV (EnTV), among other examples. For example, in eMBMS, multicast data is transmitted in multiple cells to a group of UEs located in a particular area. In SC-PTM, multicast data is transmitted in a particular cell and the multicast data is received by a group of UEs that are located in the particular cell. In an NR network, a UE 120 may receive multicast broadcast services in mixed mode or broadcast mode. For example, in mixed mode, a UE 120 in an RRC connected mode may receive multicast broadcast service using a multicast broadcast radio bearer (MRB) or a dedicated radio bearer (DRB). In broadcast mode, a UE 120 may receive multicast broadcast service using an MRB in an RRC connected mode, an RRC idle mode, or an RRC inactive mode.

For example, the UE 120 may support a connected communication state (for example, an RRC connected state), an idle communication state (for example, an RRC idle state), and an inactive communication state (for example, an RRC inactive state). The RRC inactive state may functionally reside between the RRC connected state and the RRC idle state. The RRC connected state, the RRC idle state, and the RRC inactive state may also be referred to as an RRC connected mode, an RRC idle mode, and an RRC inactive mode. The UE may transition between different RRC states based at least in part on various commands and/or communications received from the one or more network nodes 110. For example, the UE may transition from the RRC connected state or RRC inactive state to the RRC idle state based on, responsive to, or otherwise associated with receiving an RRC release communication (for example, an RRCRelease communication). As another example, the UE may transition from the RRC active state to the RRC inactive state based on, responsive to, or otherwise associated with receiving an RRC release communication (for example, an RRCRelease with suspendConfig communication). As another example, the UE may transition from the RRC idle state to the RRC connected state based on, responsive to, or otherwise associated with receiving an RRC setup request communication (for example, an RRCSetupRequest communication). As another example, the UE may transition from the RRC inactive state to the RRC connected state based at least in part on receiving an RRC resume request communication (for example, an RRCResumeRequest communication).

When transitioning to the RRC inactive state, the UE and/or the one or more network nodes 110 may store a UE context (for example, an access stratum (AS) context and/or higher-layer configurations). This permits the UE and/or the one or more network nodes 110 to apply the stored UE context when the UE transitions from the RRC inactive state to the RRC connected state in order to resume communications with the one or more network nodes 110, which reduces latency of transitioning to the RRC connected state relative to transitioning to the RRC connected state from the RRC idle state.

As shown in FIG. 4, the MBS architecture 400 may include a multicast broadcast user plane function (MB-UPF) that receives (for example, from an application server) a multicast broadcast (MB) flow including content to be multicasted or broadcasted. As further shown, the MBS architecture 400 may include a centralized network node unit (gNB-CU), such as a CU, that receives the MB flow and a temporary mobile group identity (TMGI) associated with the MB flow from the MB-UPF over an MB-N3 tunnel (for example, a user plane interface for delivering the MB flow and the corresponding TMGI using a general packet radio service tunneling protocol (GTP)). Furthermore, the gNB-CU may communicate with an access and mobility management function (AMF) that manages UE network registration, manages mobility, maintains non-access stratum (NAS) signaling connections, or manages UE registration procedures, among other examples. For example, the gNB-CU may communicate with the AMF over an N2 interface that enables control signaling to establish or modify the MB flow or the TMGI.

In some examples, the gNB-CU may map the MB flow received from the MB-UPF to an MRB or a DRB based at least in part on the TMGI associated with the MB flow, and the gNB-CU may forward the MB flow to a DU (for example, DU₁ or DU₂ shown in FIG. 4) that may include one or more TRPs, which may multicast or broadcast the content included in the MB flow to one or more UEs (for example, UE₁₋₁-UE₁₋ₙ or UE₂₋₁-UE₂₋ₙ shown in FIG. 4) via an MRB (for example, MRB₁ or MRB₂ shown in FIG. 4). Additionally or alternatively, the DU may transmit the content included in the MB flow to one or more UEs via a DRB. In this way, the multicast broadcast service architecture may flexibly switch between transmitting content to UEs via a DRB (or a unicast bearer) and an MRB, and may provide unicast assistance to the MRB at lower layers to improve reliability or reduce service disruption.

Multicast or broadcast transmissions in an NR network may be supported using a multicast broadcast traffic channel (MTCH) and a multicast broadcast control channel (MCCH). The MTCH may carry multicast or broadcast data, while the MCCH may carry configuration information or control information for multicast or broadcast communications to be transmitted on the MTCH. An MBS communication on the MTCH may be addressed to a group of UEs using a group common radio network temporary identifier (G-RNTI). The MCCH may carry configuration information for configuring the MTCHs, and may be addressed to all UEs in a cell (for example, a physical cell or a virtual cell) using a single cell RNTI (SC-RNTI). In some examples, there may be a single MCCH per cell (physical cell or virtual cell), and the MCCH may carry MTCH configuration information for multiple multicast broadcast services with different MB-QoS flows. The MCCH and the MTCH may be logical channels. The MCCH and the MTCH may be mapped to a downlink shared channel (DL-SCH) transport channel. The DL-SCH transport channel may be mapped to a physical downlink shared channel (PDSCH).

In some examples, an MBS broadcast communication (for example, via the MCCH or the MTCH) can be received by all UEs in all RRC states (for example, RRC connected state, RRC idle state, and RRC inactive state). For example, a CSS (for example, a Type0-PDCCH CSS or Type0B-PDCCH CSS, as defined, or otherwise fixed, by a wireless communication standard, such as the 3GPP) can be configured for a search space associated with a DCI format 40 (for example, as defined, or otherwise fixed, by a wireless communication standard, such as the 3GPP) with a cyclic redundancy check (CRC) scrambled by a broadcast MCCH radio network temporary identifier (RNTI) (MCCH-RNTI) or a G-RNTI via a system information block (SIB) of a serving cell. A CSS (for example, a Type3-PDCCH CSS, as defined, or otherwise fixed, by a wireless communication standard, such as the 3GPP) can be configured for a search space of DCI format 4_0 with CRC scrambled by broadcast MCCH-RNTI or G-RNTI on a secondary cell (Scell) for UEs operating in the RRC connected state. In some examples, if an active downlink bandwidth part (BWP) and an MBS frequency resource (for example, indicated by a cfr-ConfigMCCH-MTCH configuration or determined by a control resource set (CORESET), such as CORESET0 when cfr-ConfigMCCH-MTCH is not configured) have the same numerology (for example, a same subcarrier spacing (SCS) and same cyclic prefix (CP) length) and the active downlink BWP includes all resource blocks (RBs) of the MBS frequency resource, and if the UE is configured with a search space configuration for the MCCH or the MTCH (for example, via a searchSpaceMCCH configuration or searchSpaceMTCH configuration) for a Type0B CSS set on a primary cell or for a Type3 CSS set on a secondary cell, then the UE may monitor a PDCCH for detection of broadcast DCI formats on the active downlink BWP.

In some examples, an MBS multicast communication (for example, via the MTCH) can be received by UEs operating in the RRC connected state. For example, for RRC connected UEs, a Type3 CSS (also referred to as a Type3-PDCCH CSS) can be configured for DCI format 4_1 and/or format 4_2 with a CRC scrambled by G-RNTI or a group configured scheduling RNTI (G-CS-RNTI) via a unicast RRC communication. Additionally, the retransmission of an MBS multicast PDSCH can be scheduled by multicast DCI formats (for example, DCI format 4_1/4_2 with CRC scrambled by G-RNTI or G-CS-RNTI) or by unicast DCI formats (for example, DCI format 1_0/1_1/1_2 with CRC scrambled by a cell RNTI (C-RNTI) or a cell configured scheduling RNTI (C-CS-RNTI)). In some examples, an MBS multicast communication (for example, via the MCCH and/or the MTCH) can be received by UEs operating in the RRC inactive state. For example, a UE may be configured with a Type0 CSS and/or a Type0B CSS for monitoring for multicast DCI formats (for example, DCI format 4_0 with CRC scrambled by multicast MCCH-RNTI) via a SIB or an RRC release communication. Additionally, a Type0-PDCC CSS, a Type0B-PDCC CSS, and/or a Type3-PDCCH CSS can be configured for monitoring for multicast DCI formats (for example, DCI format 4_1 with CRC scrambled by multicast G-RNTI) via a SIB or an RRC release communication.

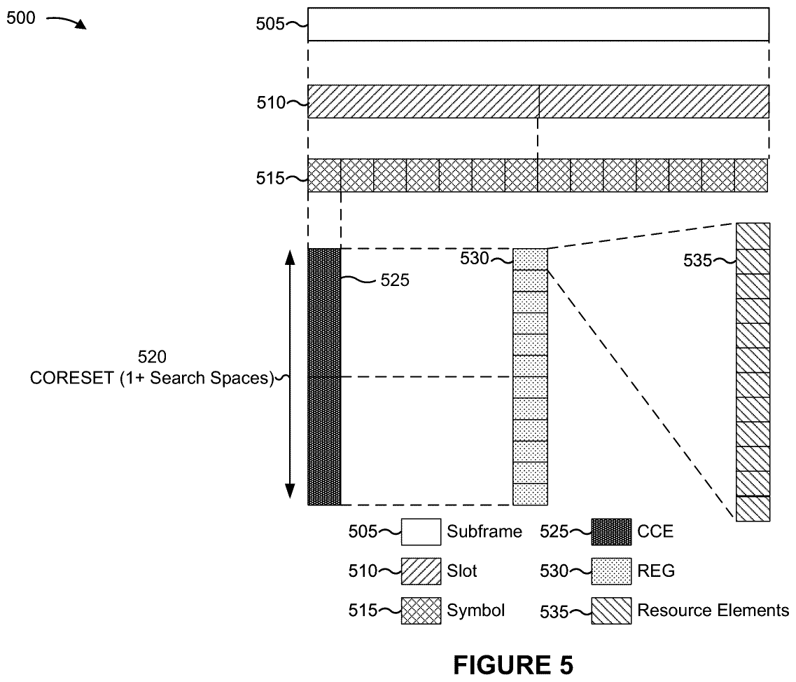

FIG. 5 is a diagram illustrating an example resource structure 500 for wireless communication in accordance with the present disclosure. Resource structure 500 shows an example of various groups of resources described herein. As shown, resource structure 500 may include a subframe 505. Subframe 505 may include multiple slots 510. While resource structure 500 is shown as including 2 slots per subframe, a different quantity of slots may be included in a subframe (for example, 4 slots, 8 slots, 16 slots, 32 slots, or another quantity of slots). In some aspects, different types of transmission time intervals (TTIs) may be used, other than subframes and/or slots. A slot 510 may include multiple symbols 515, such as 14 symbols per slot.

The potential control region of a slot 510 may be referred to as a CORESET 520 and may be structured to support an efficient use of resources, such as by flexible configuration or reconfiguration of resources of the CORESET 520 for one or more PDCCHs and/or one or more physical downlink shared channels (PDSCHs). In some aspects, the CORESET 520 may occupy the first symbol 515 of a slot 510, the first two symbols 515 of a slot 510, or the first three symbols 515 of a slot 510. Thus, a CORESET 520 may include multiple resource blocks (RBs) in the frequency domain, and either one, two, or three symbols 515 in the time domain. In 5G, a quantity of resources included in the CORESET 520 may be flexibly configured, such as by using RRC signaling to indicate a frequency domain region (for example, a quantity of resource blocks) and/or a time domain region (for example, a quantity of symbols) for the CORESET 520.

As illustrated, a symbol 515 that includes CORESET 520 may include one or more control channel elements (CCEs) 525, shown as two CCEs 525 as an example, that span a portion of the system bandwidth. A CCE 525 may include downlink control information (DCI) that is used to provide control information for wireless communication. A network node may transmit DCI during multiple CCEs 525 (as shown), where the quantity of CCEs 525 used for transmission of DCI represents the aggregation level (AL) used by the network node for the transmission of DCI. In FIG. 5, an aggregation level of two is shown as an example, corresponding to two CCEs 525 in a slot 510. In some aspects, different aggregation levels may be used, such as 1, 2, 4, 8, 16, or another aggregation level.

Each CCE 525 may include a fixed quantity of resource element groups (REGs) 530, shown as 6 REGs 530, or may include a variable quantity of REGs 530. In some aspects, the quantity of REGs 530 included in a CCE 525 may be specified by a REG bundle size. A REG 530 may include one resource block, which may include 12 resource elements (REs) 535 within a symbol 515. A resource element 535 may occupy one subcarrier in the frequency domain and one OFDM symbol in the time domain.

A search space may include all possible locations (for example, in time and/or frequency) where a PDCCH may be located. A CORESET 520 may include one or more search spaces, such as a UE-specific search space (USS), a group-common search space, and/or a CSS. A search space may indicate a set of CCE locations where a UE may find PDCCHs that can potentially be used to transmit control information to the UE. The possible locations for a PDCCH may depend on whether the PDCCH is a UE-specific PDCCH (for example, for a single UE) or a group-common PDCCH (for example, for multiple UEs) and/or an aggregation level being used. A possible location (for example, in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 520 may be interleaved or non-interleaved. An interleaved CORESET 520 may have CCE-to-REG mapping such that adjacent CCEs are mapped to scattered REG bundles in the frequency domain (for example, adjacent CCEs are not mapped to consecutive REG bundles of the CORESET 520). A non-interleaved CORESET 520 may have a CCE-to-REG mapping such that all CCEs are mapped to consecutive REG bundles (for example, in the frequency domain) of the CORESET 520.

A wireless communication system may support control channel monitoring adaptation (for example, PDCCH monitoring adaptation) that enables a manner in which the UE monitors a control channel (for example, the PDCCH) to be adapted. Control channel monitoring adaptation can be used to, for example, manage unpredictable random jitter when receiving data traffic and to reduce UE battery consumption. Control channel monitoring adaptation can be particularly useful for extended reality (XR) traffic or another type of traffic that is prone to unpredictable random jitter.

In one example of control channel monitoring adaptation, an SS set group in which the UE monitors the PDCCH can be switched between a relatively sparse SS set group to enable sparse PDCCH monitoring (for example, to conserve UE battery power before data intended for the UE is transmitted) and a relatively dense SS set group to enable dense PDCCH monitoring (for example, to facilitate fast scheduling of remaining data intended for the UE). Such SSSG switching can allow unpredictable random jitter to be managed with respect to data arrival at the UE 120. There is some tradeoff between latency and capacity loss due to the sparse PDCCH monitoring and the power saving gain. For example, sparse PDCCH monitoring in every other slot can achieve a material power saving gain (for example, greater than 5%) with a marginal capacity loss (for example, keeping a satisfied UE rate of greater than 80%).

For example, a UE 120 may perform SSSG switching. As described herein, an SSSG may be a group of one or more search space sets. In some examples, multiple groups (for example, two groups) of search space sets may be configured. For example, a search space set for the UE 120 may be associated with a first search space set group (SSSG #0), a second search space set group (SSSG #1), and/or a third search space set group (SSSG #2). In some examples, the search space sets associated with SSSG #0 may correspond to dense PDCCH measurement occasions (MOs) (for example, short search space set periodicities) and may be used outside of a channel occupancy time (COT). The search space sets associated with SSSG #1 may correspond to sparse PDCCH MOs (for example, long search space set periodicities), and may be used within the COT. In some examples, switching mechanisms between SSSG #0 and SSSG #1 may be explicit (for example, a bit in a DCI communication), or may be implicit (for example, PDCCH decoding based), with the assistance of an automatic fallback timer.

In some examples, a switching boundary may be located between the first search space group (for example, SSSG #0) and the second search space group (for example, SSSG #1). In some examples, for multi-slot PDCCH monitoring, the SSSG switching boundary may be aligned with the slot group boundary. For example, after an SSSG switching indication (explicit or implicit), the new SSSG may start at the first slot group that is located at least a given quantity of symbols (for example, P_{switch}) after the switching indication. P_{switch} may be the switching delay that is RRC configured. In some examples, for multi-slot PDCCH monitoring, the SSSG switching boundary may be aligned with the slot boundary. For example, after the SSSG switching indication (explicit or implicit), the new SSSG may start at the first slot that is at least P_{switch} symbols after the switching indication. As an example, a first codepoint in a DCI communication may indicate that the UE is to stop monitoring SS sets associated with the SSSG #1 and the SSSG #2 and to monitor SS sets associated with SSSG #0. A second codepoint in a DCI communication may indicate that the UE is to stop monitoring SS sets associated with the SSSG #0 and the SSSG #2 and to monitor SS sets associated with SSSG #1. A third codepoint in a DCI communication may indicate that the UE is to stop monitoring SS sets associated with the SSSG #0 and the SSSG #1 and to monitor SS sets associated with SSSG #2.

After the first slot after switching to SSSG #1 or SSSG #2, the UE may set (for example, initiate) an SSSG switching timer. The UE may reset the timer after a slot in which the UE detects a DCI associated with a unicast PDCCH communication (for example, a DCI format with CRC scrambled by C-RNTI/CS-RNTI/MCS-C-RNTI). Otherwise, the UE may decrease the timer by one after each slot. If the UE monitors the PDCCH using SSSG #1 or SSSG #2 and the timer expires (for example, timer value reaches zero), then the UE may switch to monitoring PDCCH using SSSG #0 (for example, a default SSSG), such as after an application delay. The application delay may be, or may include, the switching delay (for example, P_{switch}). Additionally or alternatively, the application delay may be, or may include, one or more other delays, such as a decoding delay, a UE processing delay, and/or other delays.

Control channel monitoring adaptation also includes PDCCH skipping. “PDCCH skipping” refers to a UE skipping the monitoring of a PDCCH (for example, refraining from monitoring the PDCCH) for some period of time. In one example, the UE can be provided an indication to perform PDCCH skipping (for example, an indication to skip PDCCH monitoring) for a remainder of an active time of a discontinuous reception (DRX) cycle (for example, to conserve UE battery power).

Typically, when a UE is configured for DRX, a first scheduling downlink control information (DCI) for a data burst intended for the UE would carry an indication to perform an SS set group switch (for example, to switch from sparse PDCCH monitoring to dense PDCCH monitoring), and a last scheduling DCI for the data burst would carry an indication to perform PDCCH skipping for the remainder of the active time of the DRX cycle.

One PDCCH adaptation configuration to support the above example is shown in Table 1:

TABLE 1

| Codepoint | Operation |
|---|---|
| 00 | UE monitors PDCCH in SSSG#0 |
| 01 | UE monitors PDCCH in SSSG#1 |
| 10 | PDCCH skipping for duration T1 |
| 11 | PDCCH skipping for duration T2 |

In this example, two bits in scheduling DCI can be used for indicating a PDCCH adaptation behavior of the UE. As indicated in Table 1, one of two SS set groups can be indicated in the scheduling DCI, or one of two PDCCH skipping durations can be indicated in the scheduling DCI. For example, for PDCCH skipping, the UE can be indicated (for example, via a codepoint in a DCI) to monitor the PDCCH as configured (for example, PDCCH skipping is not activated and/or triggered), such as via the codepoint 00 or the codepoint 01 shown in Table 1. Alternatively, the UE can be indicated (for example, via a codepoint in a DCI) to stop PDCCH monitoring for a duration of X (for example, where X is one of up to three (3) RRC configured values), such as via the codepoint 10 or the codepoint 11 shown in Table 1. The more PDCCH skipping durations that can be indicated, the more likely that the UE can seamlessly sleep until a nominal arrival time of a data burst, thereby increasing power savings.

In some examples, control channel monitoring adaptation may be applied for one or more types of search spaces. For example, control channel monitoring adaptation may be applied for USSs and/or for Type3-PDCCH CSSs (for example, for power savings). The UE may always monitor other search spaces regardless of whether control channel monitoring adaptation is activated or triggered. Additionally, control channel monitoring adaptation may be applied only for a scheduling cell (for example, for self-scheduling and cross-carrier scheduling). In other words, a single DCI indicating that control channel monitoring adaptation is to be applied for multiple cells may not be supported. In some examples, control channel monitoring adaptation may be applied for monitoring for DCI formats that are associated with scheduling unicast data. “Unicast” may refer to a transmission to a single recipient (for example, a one-to-one transmission).

However, as described elsewhere herein, MBS (for example, for MBS multicast and/or for MBS broadcast) and control channel monitoring adaptation may be applicable to some search space types. For example, a Type3-PDCCH CSS may be configured to enable a UE to monitor for DCI formats associated with scheduling MBS data (for example, MBS broadcast data and/or MBS multicast data). Additionally, control channel monitoring adaptation may be applicable to Type3-PDCCH CSSs. Therefore, in some examples, a UE may receive an indication that control channel monitoring adaptation is to be applied to a search space (for example, a Type3-PDCCH CSS) that is configured for monitoring for DCI formats associated with scheduling MBS data. However, control channel monitoring adaptation operations are not defined for the MBS (for example, the control channel monitoring adaptation operations are only defined for monitoring for DCI formats associated with scheduling unicast data). Therefore, because the control channel monitoring adaptation operations are not defined for the MBS, the UE and a network node may not be synchronized as to how or if control channel monitoring adaptation is to be applied to UE monitoring operation(s) for DCI formats associated with scheduling MBS data. As a result, the UE may perform the control channel monitoring adaptation (for example, when the network node does not expect that the control channel monitoring adaptation to be performed), resulting in the UE failing to receive one or more DCI communications associated with scheduling MBS data. Alternatively, the UE may not perform the control channel monitoring adaptation (for example, when the network node expects the control channel monitoring adaptation to be performed by the UE), resulting in the UE consuming processing resources, computing resources, and/or power resources associated with needlessly monitoring the search space for DCI formats associated with scheduling MBS data (for example, because the network node may refrain from transmitting DCI communications via the search space when the network node expects the control channel monitoring adaptation to be performed).

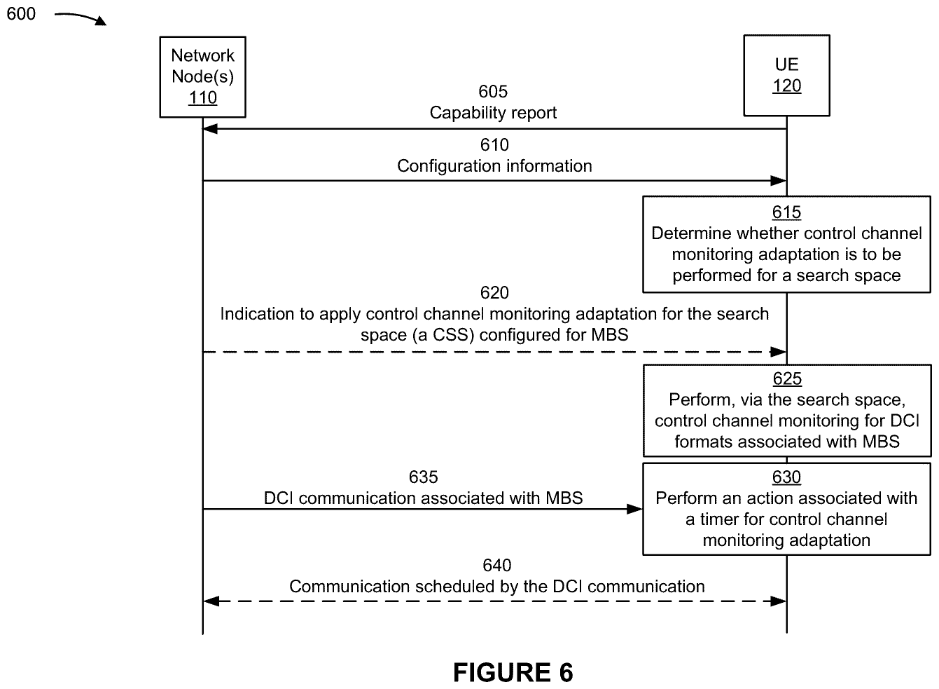

FIG. 6 is a diagram of an example associated with operations 600 associated with control channel monitoring adaptation for an MBS in accordance with the present disclosure. As shown in FIG. 6, one or more network nodes 110 (for example, a base station, a CU, a DU, and/or an RU) may communicate with a UE 120. In some aspects, the network node(s) 110 and the UE 120 may be part of a wireless network (for example, wireless network 100). In some aspects, the UE 120 and the network node(s) 110 may have established a wireless connection prior to operations shown in FIG. 6. In other aspects, the UE 120 may be operating in a state (for example, an RRC state) without an active wireless connection with the network node 110, such as in an RRC idle state or an RRC inactive state.

In some aspects, in a first operation 605, the UE 120 may optionally transmit, and the network node 110 may receive, a capability report. In some other aspects, the UE 120 may not transmit the capability report (for example, and the network node 110 may configure the UE 120 without information indicated by the capability report described herein). The UE 120 may transmit the capability report via an uplink communication, a UE assistance information (UAI) communication, an uplink control information (UCI) communication, an uplink MAC control element (MAC-CE) communication, an RRC communication, a physical uplink control channel (PUCCH), and/or a physical uplink shared channel (PUSCH), among other examples. The capability report may indicate one or more parameters associated with respective capabilities of the UE 120. The one or more parameters may be indicated via respective information elements (IEs) included in the capability report.

The capability report may indicate whether the UE 120 supports a feature and/or one or more parameters related to the feature described herein. For example, the capability report may indicate a capability and/or parameter for applying one or more control channel monitoring adaptation parameters (for example, applying SSSG switching and/or PDCCH skipping) for monitoring for DCI formats associated with the MBS. As another example, the capability report may indicate a capability and/or parameter for applying one or more control channel monitoring adaptation parameters for a search space (for example, a Type3-PDCCH CSS) that is configured for monitoring for DCI formats associated with the MBS. In some aspects, the capability report may indicate a capability and/or parameter for respective RRC states. For example, the capability report may indicate whether the UE 120 supports one or more operations described herein when operating in various RRC states (for example, RRC connected state, RRC idle state, and/or RRC inactive state).

One or more operations described herein may be based on, responsive to, or otherwise associated with capability information of the capabilities report. For example, the UE 120 may perform a communication in accordance with the capability information, or may receive configuration information that is in accordance with the capability information. In some other aspects, the operations described herein may be performed without the transmission of and/or with the network node 110 having access to the capability information. In some aspects, the capability report may indicate whether the UE 120 supports performing control channel monitoring adaptation for a search space (for example, a Type3-PDCCH CSS) that is configured for monitoring for DCI formats associated with the MBS. In some aspects, the capability report may indicate whether the UE 120 supports performing SSSG switching for a search space (for example, a Type3-PDCCH CSS) that is configured for MBS multicast PDCCH monitoring (for example, for monitoring for DCI formats associated with MBS multicast). In some aspects, the capability report may indicate whether the UE 120 supports performing SSSG switching for a search space (for example, a Type3-PDCCH CSS) that is configured for MBS broadcast PDCCH monitoring (for example, on an SCell). In some aspects, the capability report may indicate whether the UE 120 supports performing PDCCH skipping for a search space (for example, a Type3-PDCCH CSS) that is configured for MBS multicast PDCCH monitoring (for example, for monitoring for DCI formats associated with MBS multicast). In some aspects, the capability report may indicate whether the UE 120 supports performing PDCCH skipping for a search space (for example, a Type3-PDCCH CSS) that is configured for monitoring for DCI formats associated with MBS broadcast PDCCH monitoring (for example, on an SCell).

In a second operation 610, the network node 110 may transmit, and the UE 120 may receive, configuration information. In some aspects, the UE 120 may receive the configuration information via one or more of system information (for example, a master information block (MIB) and/or a SIB), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (for example, an indication described herein) may include a dynamic indication, such as one or more MAC-CEs and/or one or more DCI messages, among other examples.

In some aspects, the configuration information may be for a search space (for example, a search space configuration). The search space may be a CSS. The search space may be associated with a search space type. In some aspects, the search space type may be a search space type for which one or more control channel monitoring adaptation parameters are applicable. For example, the search space may be a Type3 CSS (for example, a Type3-PDCCH CSS). As described elsewhere herein, control channel monitoring adaptation (for example, one or more control channel monitoring adaptation parameters) may be applicable to the Type3 CSS. The Type3 CSS may be a PDCCH common search space set configured by a SearchSpace information element in a PDCCH-Config configuration with a searchSpaceType information element set to “common” for DCI formats with CRC scrambled by one or more RNTIs. The SearchSpace information element may indicate one or more DCI formats for which the Type3 CSS (for example, a Type3-PDCCH CSS) is configured. The one or more DCI formats may be associated with the MBS (for example, may be MBS DCI formats), as described elsewhere herein (such as a DCI format 4_0, a DCI format 4_1, a DCI format 4_2, or a unicast DCI format associated with scheduling a retransmission of an MBS data communication). For example, the UE 120 may be configured to monitor for DCI format(s) (for example, MBS DCI formats) indicated by the SearchSpace information element via the search space (for example, via a CORESET associated with the search space).

In some aspects, the configuration information may indicate one or more parameters for monitoring for DCI associated with the MBS, such as a CORESET (for example, provided in a PDCCH-Config-Multicast information element (IE)), a search space set (for example, provided in a SearchSpaceMulticast IE of a PDCCH-Config-Multicast IE), and/or one or more MBS DCI formats (for example, DCI format 4_0, DCI Format 4_1, or DCI Format 4_2, indicated in a SearchSpaceMulticast IE or a SearchSpaceBroadcast IE in the PDCCH-ConfigCommon), among other examples. In some aspects, the UE 120 may receive the configuration information via unicast RRC signaling, such as while the UE 120 is in the RRC connected state. As another example, the UE 120 may receive the configuration information via a SIB or another RRC communication, such as an RRC release communication. For example, the search space (for example, the Type3-PDCCH CSS) may be configured via the SearchSpace-Multicast IE in the PDCCH-Config-Multicast configuration for DCI formats with CRC scrambled by G-RNTI, or G-CS-RNTI (for example, for monitoring for DCI formats associated with scheduling MBS multicast communications). As another example, the search space (for example, the Type3-PDCCH CSS) may be configured by the searchSpace-Broadcast IE in PDCCH-Config-MCCH and/or PDCCH-Config-MTCH on a secondary cell for a DCI format 4_0 with CRC scrambled by an MCCH-RNTI or a G-RNTI.

A control channel monitoring adaptation parameter may be a parameter that is indicative of whether a type of control channel monitoring adaptation is to be applied for monitoring a PDCCH via a given search space. For example, a control channel monitoring adaptation parameter (for example, indicated via DCI, such as in a fourth operation 620 described herein) may indicate whether SSSG switching is to be applied. As another example, a control channel monitoring adaptation parameter (for example, indicated via DCI, such as in the fourth operation 620) may indicate whether PDCCH skipping is to be applied.

The configuration information may indicate that the search space is configured for the MBS. For example, the configuration information may indicate that the search space is configured for monitoring for DCI formats that are associated with the MBS. As an example, the configuration information may indicate that the CSS (for example, the Type3-PDCCH CSS) is configured as a search space for a DCI format 4_0 with a CRC scrambled by an RNTI associated with MBS broadcast (for example, an MCCH-RNTI or G-RNTI), such as on an SCell for UEs operating in the RRC connected state. As another example, the configuration information may indicate that the CSS (for example, the Type3-PDCCH CSS) is configured as a search space for a DCI format 4_1 and/or a DCI format 4_2 with a CRC scrambled by a G-RNTI or a G-CS-RNTI (for example, where the configuration information is transmitted via a unicast RRC communication). As another example, the configuration information may indicate that a retransmission of an MBS multicast PDSCH communication can be scheduled by DCI having a multicast DCI format (for example, a DCI format 4_1 and/or a DCI format 4_2 with CRC scrambled by G-RNTI or G-CS-RNTI) or by DCI having a unicast DCI format (for example, a DCI format 1_0, a DCI format 1_1, and/or a DCI format 1_2 with CRC scrambled by C-RNTI or C-CS-RNTI). As another example, the configuration information may indicate that the CSS (for example, the Type3-PDCCH CSS) is configured as a search space for a DCI format 4_1 with CRC scrambled by multicast G-RNTI (for example, configured via a SIB or an RRC release communication).

In some aspects, the configuration information may indicate whether the UE 120 is to apply control channel monitoring adaptation when monitoring the search space (for example, the Type3-PDCCH CSS that is configured for MBS). For example, the configuration information may include one or more parameters or IEs indicating whether the UE 120 is to apply control channel monitoring adaptation for a search space that is configured for monitoring DCI associated with the MBS. In some aspects, the configuration information may include one or more parameters or IEs indicating whether the UE 120 is to apply control channel monitoring adaptation (for example, for a search space that is configured for monitoring DCI associated with the MBS) for a given RRC state (for example, RRC connected state, RRC inactive state, and/or RRC idle state).

As another example, the configuration information may include one or more parameters or IEs indicating whether the UE 120 is to apply SSSG switching (for example, for a search space that is configured for monitoring DCI associated with MBS multicast) when the UE 120 is operating in the RRC connected state or in the RRC inactive state. Additionally or alternatively, the configuration information may include one or more parameters or IEs indicating whether the UE 120 is to apply SSSG switching (for example, for a search space that is configured for monitoring DCI associated with MBS broadcast) when the UE 120 is operating in the RRC connected state, in the RRC inactive state, and/or in the RRC idle state. Additionally or alternatively, the configuration information may include one or more parameters or IEs indicating whether the UE 120 is to apply PDCCH skipping (for example, for a search space that is configured for monitoring DCI associated with MBS multicast) when the UE 120 is operating in the RRC connected state or in the RRC inactive state. Additionally or alternatively, the configuration information may include one or more parameters or IEs indicating whether the UE 120 is to apply PDCCH skipping (for example, for a search space that is configured for monitoring DCI associated with MBS broadcast) when the UE 120 is operating in the RRC connected state, in the RRC inactive state, and/or in the RRC idle state.

In some aspects, the application of control channel monitoring adaptation for a search space configured for MBS operations may be defined, or otherwise fixed, by a wireless communication standard, such as the 3GPP. In such examples, the network node 110 may not indicate (for example, via the configuration information) whether the UE 120 is to apply control channel monitoring adaptation when monitoring the search space (for example, the Type3-PDCCH CSS that is configured for MBS).

In some aspects, the configuration information may indicate an SSSG configuration. For example, the configuration information may indicate a group index for a respective Type3-PDCCH CSS set or a USS set via a searchSpaceGroupldList IE or for PDCCH monitoring on a serving cell. Additionally or alternatively, the configuration information may indicate a group index for a respective Type3-PDCCH CSS set or a USS set via a searchSpaceGroupldList IE for PDCCH monitoring on an active downlink BWP of a serving cell. Additionally or alternatively, the configuration information may indicate a cellGroupsForSwitchList IE indicating one or more groups of serving cells (for example, a primary cell and/or one or more SCells) for which PDCCH monitoring is applicable.

If the UE is configured with (for example, is provided) the searchSpaceGroupldList IE for a search space set, then control channel monitoring adaptation (for example, PDCCH monitoring adaptation) may be configured and/or applicable for the search space set. If the UE is not provided a searchSpaceGroupldList IE for a search space set, then search space set group switching may not be applicable for PDCCH monitoring in accordance with the search space set. The configuration information may indicate a set of durations of PDCCH skipping via a pdcch-SkippingDurationList IE for a Type3-PDCCH CSS set or a USS set for PDCCH monitoring on an active downlink BWP of a serving cell. If the configuration information does not indicate a pdcch-SkippingDurationList IE for a given search space set, then the skipping of PDCCH monitoring (for example, PDCCH skipping) may not be applicable for the search space set.

In some aspects, the configuration information may indicate that the search space (for example, the Type3-PDCCH CSS) is configured either via the SSSG configuration or for the one or more MBS DCI formats in association with the RRC state being the RRC connected state. For example, UEs operating in the RRC connected state may not expect a Type3-PDCCH CSS that is configured for MBS multicast DCI formats (and/or configured for unicast DCI formats used for MBS multicast PDSCH retransmission) to be indicated via an SSSG configuration. Additionally or alternatively, the UEs operating in the RRC connected state may not expect a Type3-PDCCH CSS configured for MBS broadcast on an SCell to be associated with the SSSG configuration. The network node 110 may refrain from including a Type3-PDCCH CSS configured for MBS multicast DCI formats or for unicast DCI formats used for MBS multicast PDSCH retransmission associated with an SSSG configuration (for example, may refrain from indicating the Type3-PDCCH CSS via a searchSpaceGroupldList IE or a pdcch-SkippingDurationList IE). In other words, search spaces (for example, Type3-PDCCH CSSs) may be configured for either monitoring for MBS operations (for example, for MBS multicast DCI formats or for unicast DCI formats used for MBS multicast PDSCH retransmission) or for PDCCH monitoring adaptation (for example, SSSG switching or PDCCH skipping), but not both.

The UE 120 may configure itself based at least in part on the configuration information. In some aspects, the UE 120 may be configured to perform one or more operations described herein based at least in part on the configuration information.

In some aspects, the configuration information described in connection with the second operation 610 and/or the capability report described in connection with the first operation 605 may include information transmitted via multiple communications. Additionally or alternatively, the network node 110 may transmit the configuration information, or a communication including at least a portion of the configuration information, before and/or after the UE 120 transmits the capability report. For example, the network node 110 may transmit a first portion of the configuration information before a transmission of the capability report, the UE 120 may transmit at least a portion of the capability report, and the network node 110 may transmit a second portion of the configuration information after receiving the capability report. In other words, at least a portion of the second operation 610 may occur before the first operation 605.

In some aspects, the network node 110 may transmit, and the UE 120 may receive, an indication to apply control channel monitoring adaptation (for example, PDCCH monitoring adaptation) for search spaces configured for MBS operations. For example, the network node 110 may dynamically activate or deactivate a feature of applying control channel monitoring adaptation (for example, PDCCH monitoring adaptation) for search spaces configured for MBS operations. The indication may be a dynamic indication. For example, the network node 110 may transmit the indication via one or more MAC-CEs and/or one or more DCI communications, among other examples.

In a third operation 615, the UE 120 may determine whether control channel monitoring adaptation is to be performed for the search space. For example, the UE 120 may determine whether control channel monitoring adaptation is to be performed for the search space that is configured for monitoring for DCI formats associated with MBS multicast operations and/or MBS broadcast operations. In some aspects, the UE 120 may determine whether control channel monitoring adaptation is to be performed for the search space based on, responsive to, or otherwise associated with a current RRC state of the UE 120. For example, an application of the one or more control channel monitoring adaptation parameters to control channel monitoring via the search state may be based on, responsive to, or otherwise associated with the RRC state of the UE 120. In some aspects, if the RRC state is the RRC inactive state or the RRC idle state, then the UE 120 may determine that control channel monitoring adaptation is not to be performed for the search space (for example, control channel monitoring adaptation may not be applicable for search spaces configured for monitoring for DCI formats associated with MBS multicast operations and/or MBS broadcast operations for UEs in the RRC inactive state or the RRC idle state). For example, the one or more control channel monitoring adaptation parameters may not be applicable to control channel monitoring via the search space in association with the RRC state being the RRC inactive state and/or the RRC idle state.

In some aspects, if the RRC state is the RRC connected state, then the UE 120 may determine that control channel monitoring adaptation may be performed for the search space (for example, control channel monitoring adaptation may be applicable for search spaces configured for monitoring for DCI formats associated with MBS multicast operations and/or MBS broadcast operations for UEs in the RRC connected state). In other aspects, control channel monitoring adaptation may not be applicable for search spaces configured for monitoring for DCI formats associated with MBS multicast operations and/or MBS broadcast operations for UEs in the RRC connected state.

In some aspects, the UE 120 may determine whether control channel monitoring adaptation is applicable to the search space (for example, the Type3-PDCCH CSS that is configured for MBS operations) based on, responsive to, or otherwise associated with the configuration information (for example, the configuration information may indicate whether control channel monitoring adaptation is applicable to the search space). Additionally or alternatively, the UE 120 may determine whether control channel monitoring adaptation is applicable to the search space (for example, the Type3-PDCCH CSS that is configured for MBS operations) based on, responsive to, or otherwise associated with information stored by the UE 120 (for example, via an original equipment manufacturer (OEM) configuration). For example, whether the control channel monitoring adaptation is applicable to the search space (for example, the Type3-PDCCH CSS that is configured for MBS operations) may be defined, or otherwise fixed, by a wireless communication standard, such as the 3GPP. In such examples, the information stored by the UE 120 may indicate the information that is defined, or otherwise fixed, by the wireless communication standard.

In some aspects, in the fourth operation 620, the network node 110 may transmit, and the UE 120 may receive, an indication to apply control channel monitoring adaptation for the search space (for example, the Type3-PDCCH CSS configured for MBS operations). For example, the indication to apply control channel monitoring adaptation may be included in DCI. As an example, a codepoint in the DCI may indicate that SSSG switching and/or PDCCH skipping is to be applied for Type3-PDCCH CSSs. For example, PDCCH skipping may be indicated by a DCI format in a BWP shared by unicast and multicast. The indication to apply control channel monitoring adaptation may be included in a search space set group switching flag field in the DCI (for example, for indicating that SSSG switching is to be applied). As another example, the indication to apply control channel monitoring adaptation may be included in a PDCCH monitoring adaptation field.

In some aspects, the UE 120 may not expect PDCCH skipping to be indicated by the DCI (for example, in a BWP shared by unicast and multicast). For example, PDCCH skipping may not apply to monitoring the search space (for example, the Type3-PDCCH CSS) for MBS multicast DCI formats and unicast DCI formats scheduling multicast PDSCH retransmission. In such examples, the UE 120 may not expect PDCCH skipping to be indicated by DCI in a BWP shared by unicast and multicast. The network node 110 may refrain from transmitting DCI in the BWP that includes an indication (for example, in a PDCCH monitoring adaptation field) that indicates that PDCCH monitoring adaptation (for example, PDCCH skipping) is to be applied.

In a fifth operation 625, the UE 120 may perform, via the search space (for example, the Type3-PDCCH CSS), control channel monitoring for DCI formats that are associated with the MBS. The UE 120 may perform the control channel monitoring in an RRC state. In some aspects, the application of one or more control channel monitoring adaptation parameters to the control channel monitoring may be based on, responsive to, or otherwise associated with the RRC state.

For example, the one or more control channel monitoring adaptation parameters may not be applicable to the control channel monitoring in association with the RRC state being the RRC inactive state or the RRC idle state. As an example, for MBS multicast DCI formats monitored while the UE 120 is operating in the RRC inactive state, SSSG switching may not apply to the MBS multicast PDCCH monitoring. As another example, if the UE 120 receives an indication to apply SSSG switching for the search space (for example, the Type3-PDCCH CSS configured for MBS multicast PDCCH monitoring) while operating in the RRC inactive state or the RRC connected state, then the UE 120 may detect an error and refrain from applying the SSSG switching. For example, the UE 120 (for example, operating in the RRC inactive state or the RRC connected state) may not expect that the search space (for example, the Type3-PDCCH CSS) that is configured for MBS multicast PDCCH monitoring to be associated with the SSSG configuration, as described elsewhere herein. Additionally or alternatively, if SSSG switching is indicated (for example, activated) for the search space, then the UE 120 (for example, while operating in the RRC connected state) may refrain from applying SSSG switching when monitoring for MBS multicast DCI formats and unicast DCI formats used for scheduling MBS multicast PDSCH retransmissions in the Type3-PDCCH CSS. In some aspects, the Type3-PDCCH CSS that is configured for MBS multicast (for example, MBS multicast DCI formats or unicast DCI formats used for MBS multicast PDSCH retransmission) may be associated with the SSSG configuration (for example, the SSSG configuration may indicate one or more identifiers associated with the Type3-PDCCH CSS), but the UE 120 (for example, while operating in the RRC inactive state or the RRC connected state) may monitor the PDCCH via the search space for MBS multicast DCI formats and unicast DCI formats for MBS multicast retransmissions of data communications (for example, PDSCH communications) rather than applying SSSG switching.

Additionally or alternatively, for MBS multicast DCI formats monitored while the UE 120 is operating in the RRC inactive state, PDCCH skipping may not apply to the MBS multicast PDCCH monitoring. For example, if the UE 120 receives an indication to apply PDCCH skipping for the search space (for example, the Type3-PDCCH CSS configured for MBS multicast PDCCH monitoring) while operating in the RRC inactive state, then the UE 120 may detect an error and refrain from applying the PDCCH skipping. For example, the UE 120 (for example, while operating in the RRC inactive state) may not expect that a DCI (for example, received via a downlink BWP shared for multicast and unicast) indicates that PDCCH skipping is to be applied to the search space (for example, the Type3-PDCCH CSS) that is configured for MBS multicast PDCCH monitoring, as described elsewhere herein. Additionally or alternatively, if PDCCH skipping is indicated (for example, activated) for the search space, then the UE 120 may refrain from applying PDCCH skipping when monitoring for MBS multicast DCI formats and unicast DCI formats used for scheduling MBS multicast PDSCH retransmissions in the search space (for example, the Type3-PDCCH CSS).

Additionally or alternatively, for MBS broadcast DCI formats monitored in the RRC inactive state or the RRC idle state, SSSG switching may not apply to the MBS broadcast PDCCH monitoring (for example, on an SCell). For example, if the UE 120 (for example, operating in the RRC inactive state or the RRC idle state) receives an indication to apply SSSG switching for the search space (for example, the Type3-PDCCH CSS configured for MBS broadcast PDCCH monitoring on an SCell), then the UE 120 may detect an error and refrain from applying the SSSG switching. For example, the UE 120 may not expect that the search space (for example, the Type3-PDCCH CSS) that is configured for MBS broadcast PDCCH monitoring on an SCell be associated with the SSSG configuration, as described elsewhere herein. Additionally or alternatively, if SSSG switching is indicated (for example, activated) for the search space, then the UE 120 may refrain from applying SSSG switching when monitoring for MBS broadcast DCI formats and unicast DCI formats used for scheduling MBS multicast PDSCH retransmissions in the Type3-PDCCH CSS. In other words, when operating in the RRC inactive state or the RRC idle state, the UE 120 may always monitor the MBS broadcast PDCCH on an SCell in the Type3-PDCCH CSS (for example, regardless of whether SSSG switching is configured, indicated, or activated).

Additionally or alternatively, for MBS broadcast DCI formats monitored while the UE 120 is operating in the RRC inactive state or the RRC idle state, PDCCH skipping may not apply to the MBS broadcast PDCCH monitoring on an SCell. For example, if the UE 120 receives an indication to apply PDCCH skipping for the search space (for example, the Type3-PDCCH CSS configured for MBS broadcast PDCCH monitoring on an SCell) while operating in the RRC inactive state or the RRC idle state, then the UE 120 may detect an error and/or may refrain from applying the PDCCH skipping. In other words, the UE 120 (for example, while operating in the RRC inactive state or the RRC idle state) may always monitor the MBS broadcast PDCCH in the Type3-PDCCH CSS (for example, regardless of whether PDCCH skipping is configured, indicated, or activated).

In some aspects, when the UE 120 is operating in the RRC connected state, control channel monitoring adaptation may be applied when monitoring the PDCCH via the search space (for example, the Type3-PDCCH CSS) for some DCI formats. For example, the UE 120 may apply control channel monitoring adaptation for PDCCH monitoring via the search space (for example, the Type3-PDCCH CSS) for unicast DCI formats (for example, that are used to schedule retransmissions of MBS data communications). For example, the one or more control channel monitoring adaptation parameters (for example, an SSSG switching parameter and/or a PDCCH skipping parameter) may not be applicable for MBS DCI formats. The one or more control channel monitoring adaptation parameters (for example, an SSSG switching parameter and/or a PDCCH skipping parameter) may be applicable for unicast DCI formats associated with scheduling a retransmission of an MBS data communication.

For example, in some aspects, SSSG switching may not be applicable to MBS multicast DCI formats, but may be applicable to unicast DCI formats that are monitored via the Type3-PDCCH CSS. For example, the configuration information may indicate that the search space is configured either as being associated with the SSSG configuration or for the one or more MBS DCI formats in association with the RRC state being the RRC connected state (for example, the UE 120 may not expect a Type3-PDCCH CSS configured for MBS multicast DCI formats to be associated with the SSSG configuration). However, a Type3-PDCCH CSS configured for unicast DCI formats that may be used to schedule retransmission of an MBS data communication may be associated with the SSSG configuration. For example, a Type3-PDCCH CSS configured for MBS multicast DCI formats may be associated with the SSSG configuration. In such examples, the UE 120 (for example, when operating in the RRC connected state) may always monitor the PDCCH via the Type3-PDCCH CSS for MBS multicast DCI formats, but may skip monitoring the PDCCH via the Type3-PDCCH CSS for unicast DCI formats (for example, when SSSG switching indication indicates that the Type3-PDCCH CSS is not to be monitored). This enables the UE 120 to conserve processing resources, computing resources, and/or power resources that would have otherwise been used to monitor the PDCCH via the Type3-PDCCH CSS for the unicast DCI format(s), while still enabling the UE 120 to receive DCI that uses the MBS multicast DCI formats.

Additionally or alternatively, PDCCH skipping may not be applicable to MBS multicast DCI formats, but may be applicable to unicast DCI formats that are monitored via the Type3-PDCCH CSS. For example, the network node 110 may refrain from transmitting a PDCCH skipping indication via DCI using a DCI format associated with a BWP that is shared for unicast and multicast operations. In other words, the UE 120 may not expect PDCCH skipping to be indicated via a DCI format in a BWP shared for unicast and multicast operations. In some aspects, the network node 110 may transmit, and the UE 120 may receive, a PDCCH skipping indication via DCI in the BWP that is shared for unicast and multicast operations (such as in the fourth operation 620). In such examples, the UE 120 may refrain from applying PDCCH skipping for monitoring the PDCCH (for example, via the Type3-PDCCH CSS) for MBS multicast DCI formats. The UE 120 may apply the PDCCH skipping for monitoring the PDCCH (for example, via the Type3-PDCCH CSS) for unicast DCI formats (for example, that are associated with scheduling a retransmission of an MBS data communication). This enables the UE 120 to conserve processing resources, computing resources, and/or power resources that would have otherwise been used to monitor the PDCCH via the Type3-PDCCH CSS for the unicast DCI format(s), while still enabling the UE 120 to receive DCI that uses the MBS multicast DCI formats.

In some aspects, when the UE 120 is operating in the RRC connected state, control channel monitoring adaptation may be applied when monitoring the PDCCH via the search space (for example, the Type3-PDCCH CSS) for MBS multicast and/or MBS broadcast DCI formats. For example, the UE 120 may apply control channel monitoring adaptation for PDCCH monitoring via the search space (for example, the Type3-PDCCH CSS) for MBS DCI formats (for example, for the MTCH and/or the MCCH). For example, the one or more control channel monitoring adaptation parameters (for example, an SSSG switching parameter and/or a PDCCH skipping parameter) may be applicable for MBS DCI formats (for example, PDCCH monitoring adaptation may be applied for MBS PDCCH monitoring). The one or more control channel monitoring adaptation parameters (for example, an SSSG switching parameter and/or a PDCCH skipping parameter) may be applicable for unicast DCI formats associated with scheduling a retransmission of an MBS data communication.

For example, SSSG switching may be applicable to PDCCH monitoring (for example via the Type3-PDCCH CSS) for monitoring for MBS DCI formats and for monitoring for unicast DCI formats. For example, the network node 110 may transmit and the UE 120 may receive, an indication to apply SSSG switching for the Type3-PDCCH CSS, such as in the fourth operation 620. For example, the indication to apply SSSG switching may indicate that the UE 120 is switch which SSSG is to be monitored (for example, for the Type3-PDCCH CSS). In such examples, the UE 120 may refrain from, or skip, PDCCH monitoring via a search space (for example, for the Type3-PDCCH CSS) for DCI formats associated with MBS multicast operations. This enables the UE 120 to conserve processing resources, computing resources, and/or power resources that would have otherwise been used to monitor the PDCCH via the Type3-PDCCH CSS for the MBS multicast DCI format(s).

Additionally or alternatively, SSSG switching may be applicable to MBS broadcast PDCCH monitoring (for example via the Type3-PDCCH CSS). For example, the network node 110 may transmit, and the UE 120 may receive, an indication to apply SSSG switching for the Type3-PDCCH CSS, such as in the fourth operation 620. For example, the indication to apply SSSG switching may indicate that the UE 120 is to switch which SSSG is to be monitored (for example, for the Type3-PDCCH CSS). The UE 120 may refrain from, or skip, PDCCH monitoring via a search space (for example, for the Type3-PDCCH CSS) for broadcast communications on an SCell. For example, if the UE 120 is provided cellGroupsForSwitchList IE (for example, that configured a cell group including the Scell) and the SCell in the cell group is associated with (for example, includes) a broadcast PDCCH configured by the search space configuration (for example, the Type3-PDCC CSS), then the UE 120 may refrain from, or skip, monitoring the broadcast PDCCH on the SCell in the Type3-PDCC CSS (for example, in accordance with the SSSG switching indication that is applicable to all cells in the cell group). For example, the UE 120 may be provided cellGroupsForSwitchList for SSSG switching, so that a single DCI (for example, transmitted in the fourth operation 620) indicates control channel monitoring adaptation for multiple cells in the cell group (for example, control channel monitoring adaptation may be applied to multiple cells via an indication in a single DCI communication).

Additionally or alternatively, PDCCH skipping may be applicable to PDCCH monitoring (for example via the Type3-PDCCH CSS) for monitoring for MBS multicast DCI formats and for monitoring for unicast DCI formats. For example, the network node 110 may transmit, and the UE 120 may receive, an indication to apply PDCCH skipping for the Type3-PDCCH CSS, such as in the fourth operation 620. The UE 120 may refrain from, or skip, monitoring the PDCCH (for example, via the Type3-PDCCH CSS) for MBS multicast DCI formats and for monitoring for unicast DCI formats (for example, for a duration indicated by the indication to apply PDCCH skipping). As a result, the UE 120 may conserve processing resources, computing resources, and/or power resources that would have otherwise been used to monitor the PDCCH via the Type3-PDCCH CSS for the MBS multicast DCI format(s).

In some aspects, for an MBS broadcast PDCCH monitored by the UE 120 while operating in the RRC connected state, PDCCH skipping may not be applicable to the PDCCH monitoring (for example, even if the Type3-PDCCH CSS is configured for MBS broadcast PDCCH on an SCell). For example, because a cellGroupsForSwitchList IE may not be configured for the MBS broadcast PDCCH, the UE 120 may not apply PDCCH skipping for PDCCH monitoring of an MBS broadcast PDCCH via the Type3-PDCCH CSS on the SCell. In other aspects, for an MBS broadcast PDCCH monitored by the UE 120 while operating in the RRC connected state, PDCCH skipping may be applicable to the PDCCH monitoring via the Type3-PDCCH CSS. For example, the network node 110 may transmit, and the UE 120 may receive, an indication to apply PDCCH skipping for the Type3-PDCCH CSS, such as in the fourth operation 620. For example, the indication to apply PDCCH skipping may indicate that the UE 120 is to refrain from or skip PDCCH monitoring via the search space (for example, the Type3-PDCCH CSS). The UE 120 may refrain from, or skip, PDCCH monitoring via the search space (for example, the Type3-PDCCH CSS) for broadcast communications on an SCell for a duration associated with the indication to apply PDCCH skipping. For example, the UE 120 may refrain from, or skip, monitoring the broadcast PDCCH on the SCell in the Type3-PDCC CSS (for example, in accordance with the indication to apply PDCCH skipping).

The UE 120 may monitor the control channel (for example, the PDCCH) via the search space (for example, the Type3-PDCCH CSS) in accordance with one or more of the operations described above. In some aspects, the UE 120 may apply one or more control channel monitoring adaptation parameters when performing the monitoring of the control channel via the search space (for example, the Type3-PDCCH CSS) for one or more MBS DCI formats (for example, one or more MBS multicast DCI formats and/or one or more MBS broadcast DCI formats). In other example, the UE 120 may refrain from applying the one or more control channel monitoring adaptation parameters when performing the monitoring of the control channel via the search space (for example, the Type3-PDCCH CSS) for one or more MBS DCI formats (for example, one or more MBS multicast DCI formats and/or one or more MBS broadcast DCI formats), as described in more detail elsewhere herein.

In a sixth operation 630, the UE 120 may perform an action associated with a timer for control channel monitoring adaptation. For example, a control channel monitoring adaptation parameter may be associated with the timer. In some aspects, the timer may be associated with SSSG switching. The timer may be indicated or configured via a searchSpaceSwitchingTimer IE. For example, a value of the timer may be indicated or configured via the searchSpaceSwitchingTimer IE. The UE 120 and/or the network node 110 may perform an action associated with the timer. If the UE 120 receives an indication to apply SSSG switching (such as in the fourth operation 620), then the UE 120 may reset the timer after a slot of the active downlink BWP of the serving cell if the UE detects a DCI format in a PDCCH reception in the slot with a CRC scrambled by one or more RNTIs. Otherwise (for example, if the UE 120 does not detect a DCI format in the slot), the UE 120 may decrement the timer value by one after a slot of the active downlink BWP of the serving cell. When the timer expires in a first slot, the UE 120 may monitor the PDCCH on the serving cell in accordance with search space sets with group index 0 starting in a second slot (for example, where the second slot is defined, or otherwise fixed, by 3GPP Technical Specification 38.213, Version 17.6.0, Section 10.4).

In some aspects, in association with monitoring the PDCCH as described above (for example, in the fifth operation 625), the UE 120 may receive, during a slot, a DCI communication that is scrambled by an RNTI that is associated with the MBS. The RNTI may be a group RNTI (G-RNTI) for multicast or a group configured scheduling RNTI (G-CS-RNTI) for multicast. The UE 120 may reset, after the slot, the timer in association with receiving the DCI communication. For example, the UE 120 may reset the timer after a slot of the active downlink BWP of the serving cell if the UE 120 detects a DCI format in a PDCCH reception in the slot with a CRC scrambled by C-RNTI/C-CS-RNTI/MCS-C-RNTI or by G-RNTI/G-CS-RNTI for multicast (for example, if control channel monitoring adaptation is applied for the Type3-PDCCH CSS for monitoring for MBS DCI formats, as described in more detail elsewhere herein). In other words, the timer (for example, the SSSG switching timer) may be associated with (for example, applicable to or modified based on) both unicast traffic and MBS traffic (for example, MBS multicast traffic). For example, the UE 120 may reset the timer in association with (for example, based on or in response to) receiving DCI that is associated with unicast traffic and/or MBS traffic (for example, MBS multicast traffic).

As another example, the UE 120 may reset the timer only in association with receiving DCI communications having DCI formats associated with an RNTI that is associated with unicast data communications and/or unicast retransmission for multicast data. For example, the UE 120 may reset the timer after a slot of the active downlink BWP of the serving cell if the UE 120 detects a DCI format in a PDCCH reception in the slot with a CRC scrambled by C-RNTI/C-CS-RNTI/MCS-C-RNTI for unicast data only. In other words, the UE 120 may not reset the timer after a slot of the active downlink BWP of the serving cell if the UE 120 detects a DCI format in a PDCCH reception in the slot with a CRC scrambled by G-RNTI/G-CS-RNTI for MBS multicast or by C-RNTI/C-CS-RNTI for MBS multicast PDSCH retransmission.

As another example, the UE 120 may reset the timer only in association with receiving DCI communications having DCI formats associated with a C-RNTI, a C-CS-RNTI, or an MCS-C-RNTI (for example, if control channel monitoring adaptation is not applied for the Type3-PDCCH CSS for monitoring for MBS DCI formats, as described elsewhere herein). For example, the UE 120 may reset the timer after a slot of the active downlink BWP of the serving cell only if the UE detects a DCI format in a PDCCH reception in the slot with a CRC scrambled by C-RNTI/C-CS-RNTI/MCS-C-RNTI. In other words, the UE 120 may refrain from resetting (for example, not reset) the timer after a slot of the active downlink BWP of the serving cell if the UE 120 detects a DCI format in a PDCCH reception in the slot with a CRC scrambled by G-RNTI/G-CS-RNTI for multicast (for example, if control channel monitoring adaptation is not applied for the Type3-PDCCH CSS for monitoring for MBS DCI formats but is applied for monitoring for unicast DCI formats that schedule retransmissions of MBS data communications, as described elsewhere herein).

In some aspects, the UE 120 may receive (for example, in a seventh operation 635) a DCI communication (for example, via an MBS broadcast PDCCH) that is scrambled by an RNTI that is associated with the MBS. In such an example, the UE 120 may refrain from resetting the timer in association with receiving the DCI communication. In other words, the UE 120 may not reset the timer after a slot of the active downlink BWP if the UE 120 detects a DCI format in a PDCCH reception in the slot with a CRC scrambled by MCCH-RNTI/G-RNTI for broadcast on SCell. For example, when the UE 120 does not apply SSSG switching for MBS broadcast PDCCH via a Type3-PDCCH CSS, then the UE 120 may refrain from resetting the timer based on, responsive to, or otherwise associated with receiving a DCI communication (for example, via an MBS broadcast PDCCH on an SCell) that is scrambled by an RNTI that is associated with the MBS.

In other aspects, the UE 120 may receive (for example, in the seventh operation 635) a DCI communication (for example, via an MBS broadcast PDCCH) that is scrambled by an RNTI that is associated with the MBS on an SCell. The UE 120 may receive, via the search space, a DCI communication that is scrambled by an RNTI that is associated with an MBS broadcast communication on a secondary cell (for example, an MCCH-RNTI and/or a G-RNTI). The UE 120 may reset the timer based on, responsive to, or otherwise associated with receiving the DCI communication. For example, the UE 120 may reset the timer after a slot of the active downlink BWP if the UE 120 detects a DCI format in a PDCCH reception in the slot with a CRC scrambled by MCCH-RNTI/G-RNTI for broadcast on an SCell.

The network node 110 may determine the PDCCH monitoring operation(s) of the UE 120 (for example, as described in connection with the fifth operation 625) in a similar manner as described in more detail elsewhere herein. For example, the network node 110 may determine whether the UE 120 is monitoring the PDCCH (for example, via the Type3-PDCCH CSS) based on, responsive to, or otherwise associated with whether one or more control channel monitoring adaptation parameters are applicable to monitoring the PDCCH for MBS DCI formats, as described in more detail elsewhere herein. Additionally, the network node 110 may determine whether the UE 120 has reset the timer (for example, as described in connection with the sixth operation 630) in a similar manner as described above.

In some aspects, in the seventh operation 635, the network node 110 may transmit, and the UE 120 may receive, a DCI communication associated with the MBS. For example, the DCI communication may be associated with a DCI format that is associated with the MBS (for example, the DCI format 4_0, the DCI format 4_1, and/or the DCI format 4_2). For example, the UE 120 may receive (for example, detect) the DCI communication based on, responsive to, or otherwise associated with monitoring a control channel (for example, the PDCCH) via the search space (for example, the Type3-PDCCH CSS) as described in more detail elsewhere herein, such as in connection with the fifth operation 625.

In some aspects, the DCI communication (for example, received by the UE 120 in the seventh operation 635) may schedule a communication. In an eighth operation 640, the network node 110 and the UE 120 may perform (for example, transmit and/or receive) the communication (for example, that is scheduled by the DCI communication). The communication may be a multicast communication, a broadcast communication, a unicast communication, and/or a communication scheduled via an MBS communication, among other examples.

FIG. 7 is a flowchart illustrating an example process 700 performed, for example, at a UE or an apparatus of a UE that supports control channel monitoring adaptation for an MBS in accordance with the present disclosure. Example process 700 is an example where the apparatus or the UE (for example, UE 120) performs operations associated with control channel monitoring adaptation for an MBS.

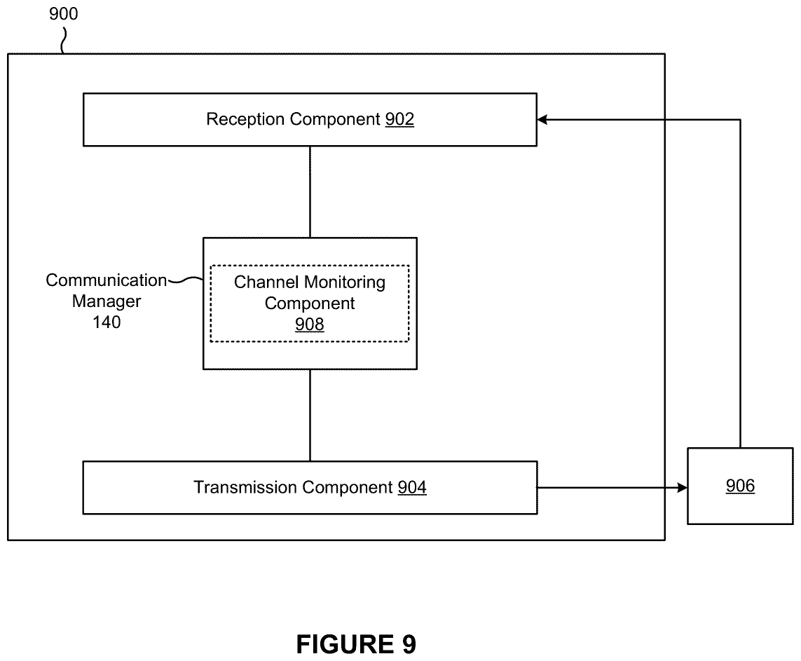

As shown in FIG. 7, in some aspects, process 700 may include receiving configuration information for a search space associated with a search space type for which one or more control channel monitoring adaptation parameters are applicable (block 710). For example, the UE (such as by using communication manager 140 or reception component 902, depicted in FIG. 9) may receive configuration information for a search space associated with a search space type for which one or more control channel monitoring adaptation parameters are applicable, as described above.

As further shown in FIG. 7, in some aspects, process 700 may include performing, in an RRC state and via the search space, control channel monitoring for one or more DCI formats that are associated with an MBS, an application of the one or more control channel monitoring adaptation parameters to the control channel monitoring being associated with the RRC state (block 720). For example, the UE (such as by using communication manager 140 or channel monitoring component 908, depicted in FIG. 9) may perform, in an RRC state and via the search space, control channel monitoring for one or more DCI formats that are associated with an MBS, an application of the one or more control channel monitoring adaptation parameters to the control channel monitoring being associated with the RRC state, as described above.

As further shown in FIG. 7, in some aspects, process 700 may optionally include performing, in association with the control channel monitoring, a communication (block 730). For example, the UE (such as by using communication manager 140 reception component 902, or transmission component 904, depicted in FIG. 9) may perform, in association with the control channel monitoring, a communication, as described above. For example, the UE may receive, based on, responsive to, or otherwise associated with performing the control channel monitoring, the communication via a control channel and the search space. As another example, the UE may receive or transmit a communication that is scheduled via a DCI communication (for example, where the DCI communication may be received via a control channel and the search space) based on, responsive to, or otherwise associated with performing the control channel monitoring.

Process 700 may include additional aspects, such as any single aspect or any combination of aspects described below or in connection with one or more other processes described elsewhere herein.

In a first additional aspect, the RRC state is an RRC inactive state, and the one or more control channel monitoring adaptation parameters are not applicable to the control channel monitoring in association with the RRC state being the RRC inactive state.

In a second additional aspect, alone or in combination with the first aspect, the one or more control channel monitoring adaptation parameters include an SSSG switching parameter, the RRC state is an RRC connected state, the configuration information includes an SSSG configuration, and the configuration information indicates that the search space is configured for either the SSSG configuration or for the one or more DCI formats in association with the RRC state being the RRC connected state.

In a third additional aspect, alone or in combination with one or more of the first and second aspects, the application of the one or more control channel monitoring adaptation parameters to the control channel monitoring is associated with whether the configuration information indicates that the search space is configured for the SSSG configuration or for the one or more DCI formats.

In a fourth additional aspect, alone or in combination with one or more of the first through third aspects, the RRC state is an RRC connected state, and the one or more control channel monitoring adaptation parameters are not applicable to the control channel monitoring in association with the RRC state being the RRC connected state.

In a fifth additional aspect, alone or in combination with one or more of the first through fourth aspects, the RRC state is an RRC connected state, and process 700 includes receiving, via the search space, a DCI communication, associated with a DCI format of the one or more DCI formats, indicating that the one or more control channel monitoring adaptation parameters are to be applied for the search space, and performing the control channel monitoring includes refraining from applying the one or more control channel monitoring adaptation parameters to the control channel monitoring in association with the RRC state being the RRC connected state.

In a sixth additional aspect, alone or in combination with one or more of the first through fifth aspects, the one or more control channel monitoring adaptation parameters include a control channel skipping parameter, and receiving a DCI communication includes receiving the DCI communication via a bandwidth part that is shared for unicast data communications and MBS communications.

In a seventh additional aspect, alone or in combination with one or more of the first through sixth aspects, the RRC state is an RRC connected state, and, in association with the RRC state being the RRC connected state, the one or more control channel monitoring adaptation parameters are not applicable for MBS DCI formats from the one or more DCI formats, and applicable for unicast DCI formats associated with scheduling a retransmission of an MBS data communication.

In an eighth additional aspect, alone or in combination with one or more of the first through seventh aspects, the one or more DCI formats include one or more MBS DCI formats, wherein the one or more control channel monitoring adaptation parameters include an SSSG switching parameter, wherein the RRC state is an RRC connected state, wherein the configuration information includes an SSSG configuration, and wherein the configuration information indicates that the search space is configured for either the SSSG configuration or for the one or more MBS DCI formats in association with the RRC state being the RRC connected state.

In a ninth additional aspect, alone or in combination with one or more of the first through eighth aspects, the one or more DCI formats include one or more MBS DCI formats, wherein the one or more control channel monitoring adaptation parameters include a control channel skipping parameter, and wherein the one or more control channel monitoring adaptation parameters are only applied in association with receiving DCI communications indicating the control channel skipping parameter via a bandwidth part that is not shared with the MBS.

In a tenth additional aspect, alone or in combination with one or more of the first through ninth aspects, the RRC state is an RRC connected state, wherein the one or more DCI formats include one or more MBS DCI formats and one or more unicast DCI formats associated with scheduling a retransmission of an MBS communication, and process 700 includes receiving, via the search space, a DCI communication indicating that the one or more control channel monitoring adaptation parameters are to be applied for the search space, and wherein performing the control channel monitoring includes refraining from applying the one or more control channel monitoring adaptation parameters for monitoring for the one or more MBS DCI formats, and applying the one or more control channel monitoring adaptation parameters for monitoring for the one or more unicast DCI formats.

In an eleventh additional aspect, alone or in combination with one or more of the first through tenth aspects, the RRC state is an RRC connected state, and performing the control channel monitoring includes applying the one or more control channel monitoring adaptation parameters to the control channel monitoring in association with the RRC state being the RRC connected state.

In a twelfth additional aspect, alone or in combination with one or more of the first through eleventh aspects, the one or more control channel monitoring adaptation parameters are associated with a timer, and performing the control channel monitoring includes receiving, during a slot, a DCI communication that is scrambled by an RNTI that is associated with the MBS, and resetting, after the slot, the timer in association with receiving the DCI communication.

In a thirteenth additional aspect, alone or in combination with one or more of the first through twelfth aspects, the RNTI is a G-RNTI for multicast or a G-CS-RNTI for multicast.

In a fourteenth additional aspect, alone or in combination with one or more of the first through thirteenth aspects, the one or more control channel monitoring adaptation parameters are associated with a timer, and performing the control channel monitoring includes resetting the timer only in association with receiving DCI communications having DCI formats associated with an RNTI that is associated with unicast data communications.

In a fifteenth additional aspect, alone or in combination with one or more of the first through fourteenth aspects, the one or more control channel monitoring adaptation parameters are associated with a timer, and performing the control channel monitoring includes resetting the timer only in association with receiving DCI communications having DCI formats associated with a C-RNTI, a C-CS-RNTI, or an MCS-C-RNTI.

In a sixteenth additional aspect, alone or in combination with one or more of the first through fifteenth aspects, process 700 includes receiving a DCI communication that is scrambled by an RNTI that is associated with the MBS, and refraining from resetting the timer in association with receiving the DCI communication.

In a seventeenth additional aspect, alone or in combination with one or more of the first through sixteenth aspects, the configuration information indicates an MBS broadcast channel associated with the search space, wherein the configuration information includes a parameter indicating one or more groups of serving cells for switching, wherein a secondary cell indicated by the parameter is associated with the MBS broadcast channel, and wherein performing the control channel monitoring includes applying the one or more control channel monitoring adaptation parameters to monitoring the MBS broadcast channel on the secondary cell in association with the secondary cell being indicated by the parameter and being associated with the MBS broadcast channel.

In an eighteenth additional aspect, alone or in combination with one or more of the first through seventeenth aspects, the one or more control channel monitoring adaptation parameters are associated with a timer, and performing the control channel monitoring includes receiving, via the search space, a DCI communication that is scrambled by an RNTI that is associated with an MBS broadcast communication on a secondary cell, and refraining from resetting the timer in association with receiving the DCI communication.

In a nineteenth additional aspect, alone or in combination with one or more of the first through eighteenth aspects, the one or more control channel monitoring adaptation parameters are associated with a timer, and performing the control channel monitoring includes receiving, via the search space, a DCI communication that is scrambled by an RNTI that is associated with an MBS broadcast communication on a secondary cell, and resetting the timer in association with receiving the DCI communication.

In a twentieth additional aspect, alone or in combination with one or more of the first through nineteenth aspects, the one or more DCI formats include at least one of one or more MBS multicast DCI formats, one or more MBS broadcast DCI formats, or one or more unicast DCI formats associated with scheduling a retransmission of an MBS communication.

In a twenty-first additional aspect, alone or in combination with one or more of the first through twentieth aspects, the one or more control channel monitoring adaptation parameters include at least one of an SSSG switching parameter, or a control channel skipping parameter.

In a twenty-second additional aspect, alone or in combination with one or more of the first through twenty-first aspects, the search space type is a Type3-PDCCH CSS that is configured for the MBS.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a network node or an apparatus of a network node that supports control channel monitoring adaptation for an MBS in accordance with the present disclosure. Example process 800 is an example where the apparatus or the network node (for example, network node 110) performs operations associated with control channel monitoring adaptation for an MBS.

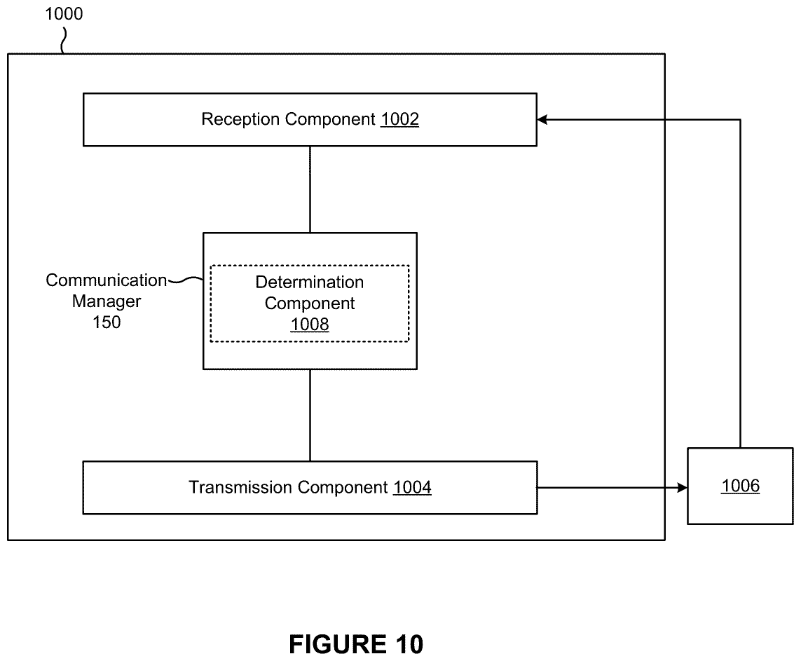

As shown in FIG. 8, in some aspects, process 800 may include transmitting configuration information for a search space associated with a search space type for which one or more control channel monitoring adaptation parameters are applicable (block 810). For example, the network node (such as by using communication manager 150 or transmission component 1004, depicted in FIG. 10) may transmit configuration information for a search space associated with a search space type for which one or more control channel monitoring adaptation parameters are applicable, as described above.

As further shown in FIG. 8, in some aspects, process 800 may include transmitting via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE (block 820). For example, the network node (such as by using communication manager 150 or transmission component 1004, depicted in FIG. 10) may transmit via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE, as described above.

Process 800 may include additional aspects, such as any single aspect or any combination of aspects described below or in connection with one or more other processes described elsewhere herein.

In a first additional aspect, the RRC state is an RRC inactive state, and the one or more control channel monitoring adaptation parameters are not applicable to the control channel monitoring in association with the RRC state being the RRC inactive state.

In a second additional aspect, alone or in combination with the first aspect, the one or more control channel monitoring adaptation parameters include an SSSG switching parameter, wherein the RRC state is an RRC connected state, wherein the configuration information includes an SSSG configuration, and wherein the configuration information indicates that the search space is configured for either the SSSG configuration or for the one or more DCI formats in association with the RRC state being the RRC connected state.

In a third additional aspect, alone or in combination with one or more of the first and second aspects, the application of the one or more control channel monitoring adaptation parameters to the control channel monitoring is associated with whether the configuration information indicates that the search space is configured for the SSSG configuration or for the one or more DCI formats.

In a fourth additional aspect, alone or in combination with one or more of the first through third aspects, the RRC state is an RRC connected state, and the one or more control channel monitoring adaptation parameters are not applicable to the control channel monitoring in association with the RRC state being the RRC connected state.

In a fifth additional aspect, alone or in combination with one or more of the first through fourth aspects, the RRC state is an RRC connected state and, in association with the RRC state being the RRC connected state, the one or more control channel monitoring adaptation parameters are not applicable for MBS DCI formats from the one or more DCI formats, and applicable for unicast DCI formats associated with scheduling a retransmission of an MBS communication.

In a sixth additional aspect, alone or in combination with one or more of the first through fifth aspects, the one or more DCI formats include one or more MBS DCI formats, wherein the one or more control channel monitoring adaptation parameters include an SSSG switching parameter, wherein the RRC state is an RRC connected state, wherein the configuration information includes an SSSG configuration, and wherein the configuration information indicates that the search space is configured for either the SSSG configuration or for the one or more MBS DCI formats in association with the RRC state being the RRC connected state.

In a seventh additional aspect, alone or in combination with one or more of the first through sixth aspects, the one or more DCI formats include one or more MBS DCI formats, wherein the one or more control channel monitoring adaptation parameters include a control channel skipping parameter, and wherein the application of the one or more control channel monitoring adaptation parameters is associated with receiving only DCI communications indicating the control channel skipping parameter via a bandwidth part that is not shared with the MBS.

In an eighth additional aspect, alone or in combination with one or more of the first through seventh aspects, the RRC state is an RRC connected state, wherein the one or more DCI formats include one or more MBS DCI formats and one or more unicast DCI formats associated with scheduling a retransmission of an MBS communication, wherein the one or more control channel monitoring adaptation parameters are not applicable for the one or more MBS DCI formats, and wherein the one or more control channel monitoring adaptation parameters are applicable for the one or more unicast DCI formats.

In a ninth additional aspect, alone or in combination with one or more of the first through eighth aspects, the RRC state is an RRC connected state, and the one or more control channel monitoring adaptation parameters are applicable in association with the RRC state being the RRC connected state.

In a tenth additional aspect, alone or in combination with one or more of the first through ninth aspects, the one or more control channel monitoring adaptation parameters are associated with a timer, and performing the control channel monitoring includes transmitting, during a slot, a DCI communication that is scrambled by an RNTI that is associated with the MBS, and resetting, after the slot, the timer in association with receiving the DCI communication.

In an eleventh additional aspect, alone or in combination with one or more of the first through tenth aspects, the RNTI is a G-RNTI for multicast or a G-CS-RNTI for multicast.

In a twelfth additional aspect, alone or in combination with one or more of the first through eleventh aspects, the one or more control channel monitoring adaptation parameters are associated with a timer, and process 800 includes resetting the timer only in association with transmitting DCI communications having DCI formats associated with an RNTI that is associated with unicast data communications.

In a thirteenth additional aspect, alone or in combination with one or more of the first through twelfth aspects, the one or more control channel monitoring adaptation parameters are associated with a timer, and process 800 includes resetting the timer only in association with transmitting DCI communications having DCI formats associated with a C-RNTI, a C-CS-RNTI, or an MCS-C-RNTI.

In a fourteenth additional aspect, alone or in combination with one or more of the first through thirteenth aspects, process 800 includes transmitting a DCI communication that is scrambled by an RNTI that is associated with the MBS, and refraining from resetting the timer in association with transmitting the DCI communication.

In a fifteenth additional aspect, alone or in combination with one or more of the first through fourteenth aspects, the configuration information indicates an MBS broadcast channel associated with the search space, wherein the configuration information includes a parameter indicating one or more groups of serving cells for switching, wherein a secondary cell indicated by the parameter is associated with the MBS broadcast channel, and wherein the one or more control channel monitoring adaptation parameters are applicable to the MBS broadcast channel on the secondary cell in association with the secondary cell being indicated by the parameter and being associated with the MBS broadcast channel.

In a sixteenth additional aspect, alone or in combination with one or more of the first through fifteenth aspects, the one or more DCI formats include at least one of one or more MBS multicast DCI formats, one or more MBS broadcast DCI formats, or one or more unicast DCI formats associated with scheduling a retransmission of an MBS communication.

In a seventeenth additional aspect, alone or in combination with one or more of the first through sixteenth aspects, the one or more control channel monitoring adaptation parameters include at least one of an SSSG switching parameter, or a control channel skipping parameter.

In an eighteenth additional aspect, alone or in combination with one or more of the first through seventeenth aspects, the search space type is a Type3-PDCCH CSS that is configured for the MBS.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports control channel monitoring adaptation for an MBS in accordance with the present disclosure. The apparatus 900 may be a UE, or a UE may include the apparatus 900. In some aspects, the apparatus 900 includes a reception component 902, a transmission component 904, and a communication manager 140, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIG. 6. Additionally or alternatively, the apparatus 900 may be configured to and/or operable to perform one or more processes described herein, such as process 700 of FIG. 7. In some aspects, the apparatus 900 may include one or more components of the UE described above in connection with FIG. 2.

The reception component 902 may receive communications, such as reference signals, control information, and/or data communications, from the apparatus 906. The reception component 902 may provide received communications to one or more other components of the apparatus 900, such as the communication manager 140. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, one or more modems, one or more demodulators, one or more MIMO detectors, one or more receive processors, one or more controllers/processors, and/or one or more memories of the UE described above in connection with FIG. 2.

The transmission component 904 may transmit communications, such as reference signals, control information, and/or data communications, to the apparatus 906. In some aspects, the communication manager 140 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 904 may be co-located with the reception component 902 in one or more transceivers.

The communication manager 140 may receive or may cause the reception component 902 to receive configuration information for a search space associated with a search space type for which one or more control channel monitoring adaptation parameters are applicable. The communication manager 140 may perform, in an RRC state and via the search space, control channel monitoring for one or more DCI formats that are associated with an MBS, an application of the one or more control channel monitoring adaptation parameters to the control channel monitoring being associated with the RRC state. In some aspects, the communication manager 140 may perform one or more operations described elsewhere herein as being performed by one or more components of the communication manager 140.

The communication manager 140 may include one or more controllers/processors, and/or one or more memories, of the UE described above in connection with FIG. 2. In some aspects, the communication manager 140 includes a set of components, such as a channel monitoring component 908. Alternatively, the set of components may be separate and distinct from the communication manager 140. In some aspects, one or more components of the set of components may include or may be implemented within one or more controllers/processors, one or more memories, of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive configuration information for a search space associated with a search space type for which one or more control channel monitoring adaptation parameters are applicable. The channel monitoring component 908 may perform, in an RRC state and via the search space, control channel monitoring for one or more DCI formats that are associated with an MBS, an application of the one or more control channel monitoring adaptation parameters to the control channel monitoring being associated with the RRC state.

The reception component 902 may receive a DCI communication that is scrambled by a RNTI that is associated with the MBS.

The channel monitoring component 908 may perform one or more operations associated with a timer in association with the application of the one or more control channel monitoring adaptation parameters. For example, the channel monitoring component 908 may refrain from resetting the timer in association with receiving the DCI communication.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports control channel monitoring adaptation for an MBS in accordance with the present disclosure. The apparatus 1000 may be a network node, or a network node may include the apparatus 1000. In some aspects, the apparatus 1000 includes a reception component 1002, a transmission component 1004, and a communication manager 150, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to and/or operable to perform one or more operations described herein in connection with FIG. 6. Additionally or alternatively, the apparatus 1000 may be configured to and/or operable to perform one or more processes described herein, such as process 800 of FIG. 8. In some aspects, the apparatus 1000 may include one or more components of the network node described above in connection with FIG. 2.

The reception component 1002 may receive communications, such as reference signals, control information, and/or data communications, from the apparatus 1006. The reception component 1002 may provide received communications to one or more other components of the apparatus 1000, such as the communication manager 150. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, one or more modems, one or more demodulators, one or more MIMO detectors, one or more receive processors, one or more controllers/processors, and/or one or more memories of the network node described above in connection with FIG. 2.

The transmission component 1004 may transmit communications, such as reference signals, control information, and/or data communications, to the apparatus 1006. In some aspects, the communication manager 150 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1004 may be co-located with the reception component 1002 in one or more transceivers.

The communication manager 150 may transmit or may cause the transmission component 1004 to transmit configuration information for a search space associated with a search space type for which one or more control channel monitoring adaptation parameters are applicable. The communication manager 150 may transmit or may cause the transmission component 1004 to transmit, via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components, such as a determination component 1008. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 1004 may transmit configuration information for a search space associated with a search space type for which one or more control channel monitoring adaptation parameters are applicable. The transmission component 1004 may transmit, via the search space and for a UE, one or more DCI communications using one or more DCI formats that are associated with an MBS in association with a control channel monitoring by the UE, an application of the one or more control channel monitoring adaptation parameters to the control channel monitoring being associated with an RRC state of the UE.

The determination component 1008 may determine whether the UE applies the one or more control channel monitoring adaptation parameters to the control channel monitoring associated with an RRC state of the UE.

The transmission component 1004 may transmit a DCI communication that is scrambled by a radio network temporary identifier (RNTI) that is associated with the MBS.

The determination component 1008 may refrain from resetting the timer in association with transmitting the DCI communication.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication by a user equipment (UE), comprising: receiving configuration information for a search space associated with a search space type for which one or more control channel monitoring adaptation parameters are applicable; and performing, in a radio resource control (RRC) state and via the search space, control channel monitoring for one or more downlink control information (DCI) formats that are associated with a multicast broadcast service (MBS), an application of the one or more control channel monitoring adaptation parameters to the control channel monitoring being associated with the RRC state. The may enable the synchronization of the application of control channel monitoring adaptation for MBS control channel monitoring (for example, so that both a network node and the UE are synchronized as to how or if the UE is applying the control channel monitoring adaptation for MBS control channel monitoring). As a result, the UE may receive one or more DCI communications associated with the MBS that may have otherwise been undetected and/or not received in association with the UE and the network node being unsynchronized as to the application of control channel monitoring adaptation for MBS control channel monitoring.

Aspect 2: The method of Aspect 1, wherein the RRC state is an RRC inactive state, and wherein the one or more control channel monitoring adaptation parameters are not applicable to the control channel monitoring in association with the RRC state being the RRC inactive state.

Aspect 3: The method of any of Aspects 1-2, wherein the one or more control channel monitoring adaptation parameters include a search space set group (SSSG) switching parameter, wherein the RRC state is an RRC connected state, wherein the configuration information includes an SSSG configuration, and wherein the configuration information indicates that the search space is configured for either the SSSG configuration or for the one or more DCI formats in association with the RRC state being the RRC connected state.

Aspect 4: The method of Aspect 3, wherein the application of the one or more control channel monitoring adaptation parameters to the control channel monitoring is associated with whether the configuration information indicates that the search space is configured for the SSSG configuration or for the one or more DCI formats.

Aspect 5: The method of any of Aspects 1-4, wherein the RRC state is an RRC connected state, and wherein the one or more control channel monitoring adaptation parameters are not applicable to the control channel monitoring in association with the RRC state being the RRC connected state.

Aspect 6: The method of any of Aspects 1-5, wherein the RRC state is an RRC connected state, and the method further comprising: receiving, via the search space, a DCI communication, associated with a DCI format of the one or more DCI formats, indicating that the one or more control channel monitoring adaptation parameters are to be applied for the search space, and wherein performing the control channel monitoring comprises: refraining from applying the one or more control channel monitoring adaptation parameters to the control channel monitoring in association with the RRC state being the RRC connected state.

Aspect 7: The method of Aspect 6, wherein the one or more control channel monitoring adaptation parameters include a control channel skipping parameter, and wherein receiving a DCI communication comprises: receiving the DCI communication via a bandwidth part that is shared for unicast data communications and MBS communications.

Aspect 8: The method of any of Aspects 1-7, wherein the RRC state is an RRC connected state, and wherein, in association with the RRC state being the RRC connected state, the one or more control channel monitoring adaptation parameters are: not applicable for MBS DCI formats from the one or more DCI formats, and applicable for unicast DCI formats associated with scheduling a retransmission of an MBS data communication.

Aspect 9: The method of any of Aspects 1-8, wherein the one or more DCI formats include one or more MBS DCI formats, wherein the one or more control channel monitoring adaptation parameters include a search space set group (SSSG) switching parameter, wherein the RRC state is an RRC connected state, wherein the configuration information includes an SSSG configuration, and wherein the configuration information indicates that the search space is configured for either the SSSG configuration or for the one or more MBS DCI formats in association with the RRC state being the RRC connected state.

Aspect 10: The method of any of Aspects 1-9, wherein the one or more DCI formats include one or more MBS DCI formats, wherein the one or more control channel monitoring adaptation parameters include a control channel skipping parameter, and wherein the one or more control channel monitoring adaptation parameters are only applied in association with receiving DCI communications indicating the control channel skipping parameter via a bandwidth part that is not shared with the MBS.

Aspect 11: The method of any of Aspects 1-10, wherein the RRC state is an RRC connected state, wherein the one or more DCI formats include one or more MBS DCI formats and one or more unicast DCI formats associated with scheduling a retransmission of an MBS communication, and the method further comprising: receiving, via the search space, a DCI communication indicating that the one or more control channel monitoring adaptation parameters are to be applied for the search space, and wherein performing the control channel monitoring comprises: refraining from applying the one or more control channel monitoring adaptation parameters for monitoring for the one or more MBS DCI formats; and applying the one or more control channel monitoring adaptation parameters for monitoring for the one or more unicast DCI formats. By applying the control channel monitoring adaptation for monitoring a search space (for example, a Type3-PDCCH CSS) for unicast DCI formats and not for MBS DCI formats, the UE may conserve processing resources, computing resources, and/or power resources that would have otherwise been used to monitor a control channel via a Type3-PDCCH CSS for the unicast DCI format(s), while still enabling the UE to receive DCI that uses an MBS DCI formats via the control channel and/or the Type3-PDCCH CSS.

Aspect 12: The method of any of Aspects 1-4, wherein the RRC state is an RRC connected state, and wherein performing the control channel monitoring comprises: applying the one or more control channel monitoring adaptation parameters to the control channel monitoring in association with the RRC state being the RRC connected state. This may enable the UE to perform or apply control channel monitoring adaptation for MBS control channel monitoring (for example, in some scenarios), thereby enabling the UE to conserve processing resources, computing resources, and/or power resources that would have otherwise been consumed in association with needlessly monitoring the search space for DCI formats associated with scheduling MBS data (for example, because the network node may refrain from transmitting DCI communications via the search space when the network node expects the control channel monitoring adaptation to be applied).

Aspect 13: The method of Aspect 12, wherein the one or more control channel monitoring adaptation parameters are associated with a timer, and wherein performing the control channel monitoring comprises: receiving, during a slot, a DCI communication that is scrambled by a radio network temporary identifier (RNTI) that is associated with the MBS; and resetting, after the slot, the timer in association with receiving the DCI communication.

Aspect 14: The method of Aspect 13, wherein the RNTI is a group RNTI (G-RNTI) for multicast or a group configured scheduling RNTI (G-CS-RNTI) for multicast.

Aspect 15: The method of any of Aspects 1-11, wherein the one or more control channel monitoring adaptation parameters are associated with a timer, and wherein performing the control channel monitoring comprises: resetting the timer only in association with receiving DCI communications having DCI formats associated with a radio network temporary identifier (RNTI) that is associated with unicast communications.

Aspect 16: The method of any of Aspects 1-11, wherein the one or more control channel monitoring adaptation parameters are associated with a timer, and wherein performing the control channel monitoring comprises: resetting the timer only in association with receiving DCI communications having DCI formats associated with a cell radio network temporary identifier (C-RNTI), a cell configured scheduling radio network temporary identifier (C-CS-RNTI), or a modulation and coding scheme cell radio network temporary identifier (MCS-C-RNTI).

Aspect 17: The method of Aspect 16, further comprising: receiving a DCI communication that is scrambled by a radio network temporary identifier (RNTI) that is associated with the MBS; and refraining from resetting the timer in association with receiving the DCI communication.

Aspect 18: The method of any of Aspects 1-4 or 12-17, wherein the configuration information indicates an MBS broadcast channel associated with the search space, wherein the configuration information includes a parameter indicating one or more groups of serving cells for switching, wherein a secondary cell indicated by the parameter is associated with the MBS broadcast channel, and wherein performing the control channel monitoring comprises: applying the one or more control channel monitoring adaptation parameters to monitoring the MBS broadcast channel on the secondary cell in association with the secondary cell being indicated by the parameter and being associated with the MBS broadcast channel.

Aspect 19: The method of any of Aspects 1-18, wherein the one or more control channel monitoring adaptation parameters are associated with a timer, and wherein performing the control channel monitoring comprises: receiving, via the search space, a DCI communication that is scrambled by a radio network temporary identifier (RNTI) that is associated with an MBS broadcast communication on a secondary cell; and refraining from resetting the timer in association with receiving the DCI communication.

Aspect 20: The method of any of Aspects 1-19, wherein the one or more control channel monitoring adaptation parameters are associated with a timer, and wherein performing the control channel monitoring comprises: receiving, via the search space, a DCI communication that is scrambled by a radio network temporary identifier (RNTI) that is associated with an MBS broadcast communication on a secondary cell; and resetting the timer in association with receiving the DCI communication.

Aspect 21: The method of any of Aspects 1-20, wherein the one or more DCI formats include at least one of: one or more MBS multicast DCI formats, one or more MBS broadcast DCI formats, or one or more unicast DCI formats associated with scheduling a retransmission of an MBS communication.

Aspect 22: The method of any of Aspects 1-21, wherein the one or more control channel monitoring adaptation parameters include at least one of: a search space set group (SSSG) switching parameter, or a control channel skipping parameter.

Aspect 23: The method of any of Aspects 1-22, wherein the search space type is a Type3 physical downlink control channel (PDCCH) common search space that is configured for the MBS.

Aspect 24: A method of wireless communication by a network node, comprising: transmitting configuration information for a search space associated with a search space type for which one or more control channel monitoring adaptation parameters are applicable; and transmitting via the search space and for a user equipment (UE), one or more downlink control information (DCI) communications using one or more DCI formats that are associated with a multicast broadcast service (MBS) in association with a control channel monitoring by the UE, an application of the one or more control channel monitoring adaptation parameters to the control channel monitoring being associated with a radio resource control (RRC) state of the UE.

Aspect 25: The method of Aspect 24, wherein the RRC state is an RRC inactive state, and wherein the one or more control channel monitoring adaptation parameters are not applicable to the control channel monitoring in association with the RRC state being the RRC inactive state.

Aspect 26: The method of any of Aspects 24-25, wherein the one or more control channel monitoring adaptation parameters include a search space set group (SSSG) switching parameter, wherein the RRC state is an RRC connected state, wherein the configuration information includes an SSSG configuration, and wherein the configuration information indicates that the search space is configured for either the SSSG configuration or for the one or more DCI formats in association with the RRC state being the RRC connected state.

Aspect 27: The method of Aspect 26, wherein the application of the one or more control channel monitoring adaptation parameters to the control channel monitoring is associated with whether the configuration information indicates that the search space is configured for the SSSG configuration or for the one or more DCI formats.

Aspect 28: The method of any of Aspects 24-27, wherein the RRC state is an RRC connected state, and wherein the one or more control channel monitoring adaptation parameters are not applicable to the control channel monitoring in association with the RRC state being the RRC connected state.

Aspect 29: The method of any of Aspects 24-28, wherein the RRC state is an RRC connected state, and wherein, in association with the RRC state being the RRC connected state, the one or more control channel monitoring adaptation parameters are: not applicable for MBS DCI formats from the one or more DCI formats, and applicable for unicast DCI formats associated with scheduling a retransmission of an MBS communication.

Aspect 30: The method of any of Aspects 24-29, wherein the one or more DCI formats include one or more MBS DCI formats, wherein the one or more control channel monitoring adaptation parameters include a search space set group (SSSG) switching parameter, wherein the RRC state is an RRC connected state, wherein the configuration information includes an SSSG configuration, and wherein the configuration information indicates that the search space is configured for either the SSSG configuration or for the one or more MBS DCI formats in association with the RRC state being the RRC connected state.

Aspect 31: The method of any of Aspects 24-30, wherein the one or more DCI formats include one or more MBS DCI formats, wherein the one or more control channel monitoring adaptation parameters include a control channel skipping parameter, and wherein the application of the one or more control channel monitoring adaptation parameters is associated with receiving only DCI communications indicating the control channel skipping parameter via a bandwidth part that is not shared with the MBS.

Aspect 32: The method of any of Aspects 24-31, wherein the RRC state is an RRC connected state, wherein the one or more DCI formats include one or more MBS DCI formats and one or more unicast DCI formats associated with scheduling a retransmission of an MBS communication, wherein the one or more control channel monitoring adaptation parameters are not applicable for the one or more MBS DCI formats, and wherein the one or more control channel monitoring adaptation parameters are applicable for the one or more unicast DCI formats.

Aspect 33: The method of any of Aspects 24-27, wherein the RRC state is an RRC connected state, and wherein the one or more control channel monitoring adaptation parameters are applicable in association with the RRC state being the RRC connected state.

Aspect 34: The method of Aspect 33, wherein the one or more control channel monitoring adaptation parameters are associated with a timer, and the method further comprising: transmitting, during a slot, a DCI communication that is scrambled by a radio network temporary identifier (RNTI) that is associated with the MBS; and resetting, after the slot, the timer in association with receiving the DCI communication.

Aspect 35: The method of Aspect 34, wherein the RNTI is a group RNTI (G-RNTI) for multicast or a group configured scheduling RNTI (G-CS-RNTI) for multicast.

Aspect 36: The method of any of Aspects 24-35, wherein the one or more control channel monitoring adaptation parameters are associated with a timer, and the method further comprising: resetting the timer only in association with transmitting DCI communications having DCI formats associated with a radio network temporary identifier (RNTI) that is associated with unicast data communications.

Aspect 37: The method of any of Aspects 24-36, wherein the one or more control channel monitoring adaptation parameters are associated with a timer, and the method further comprising: resetting the timer only in association with transmitting DCI communications having DCI formats associated with a cell radio network temporary identifier (C-RNTI), a cell configured scheduling radio network temporary identifier (C-CS-RNTI), or a modulation and coding scheme cell radio network temporary identifier (MCS-C-RNTI).

Aspect 38: The method of Aspect 37, further comprising: transmitting a DCI communication that is scrambled by a radio network temporary identifier (RNTI) that is associated with the MBS; and refraining from resetting the timer in association with transmitting the DCI communication.

Aspect 39: The method of any of Aspects 24-38, wherein the configuration information indicates an MBS broadcast channel associated with the search space, wherein the configuration information includes a parameter indicating one or more groups of serving cells for switching, wherein a secondary cell indicated by the parameter is associated with the MBS broadcast channel, and wherein the one or more control channel monitoring adaptation parameters are applicable to the MBS broadcast channel on the secondary cell in association with the secondary cell being indicated by the parameter and being associated with the MBS broadcast channel.

Aspect 40: The method of any of Aspects 24-39, wherein the one or more DCI formats include at least one of: one or more MBS multicast DCI formats, one or more MBS broadcast DCI formats, or one or more unicast DCI formats associated with scheduling a retransmission of an MBS communication.

Aspect 41: The method of any of Aspects 24-40, wherein the one or more control channel monitoring adaptation parameters include at least one of: a search space set group (SSSG) switching parameter, or a control channel skipping parameter.

Aspect 42: The method of any of Aspects 24-41, wherein the search space type is a Type3 physical downlink control channel (PDCCH) common search space that is configured for the MBS.

Aspect 43: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-42.

Aspect 44: An apparatus for wireless communication at a device, the apparatus comprising one or more memories and one or more processors coupled to the one or more memories, the one or more processors configured to cause the device to perform the method of one or more of Aspects 1-42.

Aspect 45: An apparatus for wireless communication, the apparatus comprising at least one means for performing the method of one or more of Aspects 1-42.

Aspect 46: A non-transitory computer-readable medium storing code for wireless communication, the code comprising instructions executable by one or more processors to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

Aspect 48: A device for wireless communication, the device comprising a processing system that includes one or more processors and one or more memories coupled with the one or more processors, the processing system configured to cause the device to perform the method of one or more of Aspects 1-42.

Aspect 49: An apparatus for wireless communication at a device, the apparatus comprising one or more memories and one or more processors coupled to the one or more memories, the one or more processors individually or collectively configured to cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or similar terms are intended to be open-ended terms that do not limit an element that they modify (e.g., an element “having” A may also have B). Further, as used herein, “based on” is intended to be interpreted in the inclusive sense, unless otherwise explicitly indicated. For example, “based on” may be used interchangeably with “based at least in part on,” “responsive to,” “in response to,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a processing system that includes one or more processors and one or more memories coupled with the one or more processors, the processing system configured to cause the UE to:
receive configuration information for a search space associated with a search space type for which one or more control channel monitoring adaptation parameters are applicable, the one or more control channel monitoring adaptation parameters being associated with a timer, and the timer being associated with unicast traffic and multicast broadcast service (MBS) traffic;
receive, in association with control channel monitoring of the search space, a downlink control information (DCI) communication that uses a DCI format that is associated with the MBS; and
perform an action associated with the timer in association with receiving the DCI communication.

2. The UE of claim 1, wherein the control channel monitoring is associated with a radio resource control (RRC) connected state, and wherein the processing system is further configured to cause the UE to:
apply the one or more control channel monitoring adaptation parameters to the control channel monitoring in association with the control channel monitoring being associated with the RRC connected state.

3. The UE of claim 1, wherein the DCI communication is scrambled by a radio network temporary identifier (RNTI) that is associated with the MBS, and wherein, to cause the UE to perform the action, the processing system is configured to cause the UE to:
reset, after a slot in which the DCI communication is received, the timer in association with receiving the DCI communication.

4. The UE of claim 3, wherein the RNTI is an MBS multicast RNTI.

5. The UE of claim 3, wherein the RNTI is a group RNTI (G-RNTI) for multicast or a group configured scheduling RNTI (G-CS-RNTI) for multicast.

6. The UE of claim 1, wherein the DCI communication is associated with a radio network temporary identifier (RNTI) that is associated with unicast communications, and wherein, to cause the UE to perform the action, the processing system is configured to cause the UE to:
reset the timer in association with receiving the DCI communication.

7. The UE of claim 1, wherein the DCI communication is scrambled by a radio network temporary identifier (RNTI) that is associated with MBS broadcast, and wherein, to cause the UE to perform the action, the processing system is configured to cause the UE to:
refrain from resetting the timer in association with receiving the DCI communication.

8. The UE of claim 1, wherein the DCI format includes at least one of:
one or more MBS multicast DCI formats, or
one or more MBS broadcast DCI formats.

9. The UE of claim 1, wherein the one or more control channel monitoring adaptation parameters include a search space set group (SSSG) switching parameter.

10. The UE of claim 1, wherein the search space type is a Type3 physical downlink control channel (PDCCH) common search space that is configured for the MBS.

11. The UE of claim 1, wherein the control channel monitoring is associated with a radio resource control (RRC) connected state, and wherein, to cause the UE to perform the action, the processing system is configured to cause the UE to:
reset the timer in association with the control channel monitoring being associated with the RRC connected state.

12. The UE of claim 1, wherein the control channel monitoring is associated with a radio resource control (RRC) inactive state or an RRC idle state, and wherein, to cause the UE to perform the action, the processing system is configured to cause the UE to:
refrain from resetting the timer in association with the control channel monitoring being associated with the RRC inactive state or the RRC idle state.

13. The UE of claim 1, wherein the timer is an SSSG switching timer.

14. A network node for wireless communication, comprising:
a processing system that includes one or more processors and one or more memories coupled with the one or more processors, the processing system configured to cause the network node to:
transmit configuration information for a search space associated with a search space type for which one or more control channel monitoring adaptation parameters are applicable, the one or more control channel monitoring adaptation parameters being associated with a timer, and the timer being associated with unicast traffic and multicast broadcast service (MBS) traffic; and
transmit via the search space and for a user equipment (UE), one or more downlink control information (DCI) communications using one or more DCI formats that are associated with a multicast broadcast service (MBS) in association with a control channel monitoring by the UE, an action associated with the timer being associated with the one or more DCI formats.

15. The network node of claim 14, wherein the control channel monitoring is associated with a radio resource control (RRC) connected state, and wherein the one or more control channel monitoring adaptation parameters are applicable in association with the control channel monitoring being associated with the RRC connected state.

16. The network node of claim 14, wherein the one or more DCI communications are scrambled by a radio network temporary identifier (RNTI) that is associated with the MBS, and wherein the processing system is further configured to cause the network node to:
reset, after a slot in which the one or more DCI communications are transmitted, the timer in association with transmitting the one or more DCI communications.

17. The network node of claim 16, wherein the RNTI is an MBS multicast RNTI.

18. The network node of claim 16, wherein the RNTI is a group RNTI (G-RNTI) for multicast or a group configured scheduling RNTI (G-CS-RNTI) for multicast.

19. The network node of claim 14, wherein the one or more DCI communications are scrambled by a radio network temporary identifier (RNTI) that is associated with MBS broadcast, and wherein the processing system is further configured to cause the network node to:
refrain from resetting the timer in association with transmitting the one or more DCI communications.

20. The network node of claim 14, wherein the one or more DCI formats include at least one of:
one or more MBS multicast DCI formats, or
one or more MBS broadcast DCI formats.

21. The network node of claim 14, wherein the one or more control channel monitoring adaptation parameters include at least one of:
a search space set group (SSSG) switching parameter, or
a control channel skipping parameter.

22. The network node of claim 14, wherein the search space type is a Type3 physical downlink control channel (PDCCH) common search space that is configured for the MBS.

23. A method of wireless communication by a user equipment (UE), comprising:
receiving configuration information for a search space associated with a search space type for which one or more control channel monitoring adaptation parameters are applicable, the one or more control channel monitoring adaptation parameters being associated with a timer, and the timer being associated with unicast traffic and multicast broadcast service (MBS) traffic;
receive, in association with control channel monitoring of the search space, a downlink control information (DCI) communication that uses a DCI format that is associated with the MBS; and
performing an action associated with the timer in association with receiving the DCI communication.

24. The method of claim 23, wherein the control channel monitoring is associated with a radio resource control (RRC) connected state, and wherein the method further comprises:
applying the one or more control channel monitoring adaptation parameters to the control channel monitoring in association with the control channel monitoring being associated with the RRC connected state.

25. The method of claim 23, wherein the DCI communication is scrambled by a radio network temporary identifier (RNTI) that is associated with the MBS, and wherein performing the action comprises:
resetting, after a slot in which the DCI communication is received, the timer in association with receiving the DCI communication.

26. The method of claim 25, wherein the RNTI is an MBS multicast RNTI.

27. The method of claim 25, wherein the RNTI is a group RNTI (G-RNTI) for multicast or a group configured scheduling RNTI (G-CS-RNTI) for multicast.

28. The method of claim 23, wherein the DCI communication is associated with a radio network temporary identifier (RNTI) that is associated with unicast data communications, and wherein performing the action comprises:
resetting the timer in association with receiving the DCI communication.

29. The method of claim 23, wherein the DCI communication is scrambled by a radio network temporary identifier (RNTI) that is associated with MBS broadcast, and wherein performing the action comprises:
refraining from resetting the timer in association with receiving the DCI communication.

30. A method of wireless communication by a network node, comprising:
transmitting configuration information for a search space associated with a search space type for which one or more control channel monitoring adaptation parameters are applicable, the one or more control channel monitoring adaptation parameters being associated with a timer, and the timer being associated with unicast traffic and multicast broadcast service (MBS) traffic; and
transmitting via the search space and for a user equipment (UE), one or more downlink control information (DCI) communications using one or more DCI formats that are associated with a multicast broadcast service (MBS) in association with a control channel monitoring by the UE, an action associated with the timer being associated with the one or more DCI formats.

31. The method of claim 30, wherein the control channel monitoring is associated with a radio resource control (RRC) connected state, and wherein the one or more control channel monitoring adaptation parameters are applicable in association with the control channel monitoring being associated with the RRC connected state.

32. The method of claim 30, wherein the one or more DCI communications are scrambled by a radio network temporary identifier (RNTI) that is associated with the MBS, and the method further comprising:
resetting, after a slot in which the one or more DCI communications are transmitted, the timer in association with transmitting the one or more DCI communications.

33. The method of claim 32, wherein the RNTI is an MBS multicast RNTI.

34. The method of claim 32, wherein the RNTI is a group RNTI (G-RNTI) for multicast or a group configured scheduling RNTI (G-CS-RNTI) for multicast.

35. The method of claim 30, wherein the one or more DCI communications are scrambled by a radio network temporary identifier (RNTI) that is associated with MBS broadcast, and the method further comprising:
refraining from resetting the timer in association with transmitting the one or more DCI communications.
